(19) United States
(12) Patent Application Publication
(10) Pub. No.: US 2024/0392721 A1
(43) Pub. Date: Nov. 28, 2024

(54) ENGINE ASSEMBLY FOR OFF-ROAD VEHICLES

(71) Applicants: Ralf Centmayer, Markdorf (DE); Jochen Hammerle, Waldburg (DE); Dirk Winkler, Stetten (DE); Jan Schempp, Thief River Falls, MN (US); Dominik Hermann, Thief River Falls, MN (US)

(72) Inventors: Ralf Centmayer, Markdorf (DE); Jochen Hammerle, Waldburg (DE); Dirk Winkler, Stetten (DE); Jan Schempp, Thief River Falls, MN (US); Dominik Hermann, Thief River Falls, MN (US)

(21) Appl. No.: 18/670,693

(22) Filed: May 21, 2024

Related U.S. Application Data
(60) Provisional application No. 63/545,106, filed on Oct. 20, 2023.
(60) Provisional application No. 63/544,072, filed on Oct. 13, 2023.
(60) Provisional application No. 63/542,865, filed on Oct. 6, 2023.
(60) Provisional application No. 63/468,357, filed on May 23, 2023.

(51) Int. Cl. F02B 67/06; B62M 27/02; F01L 1/02; F01M 1/02; F01P 5/12; F02B 33/40; F02B 63/04; F02N 11/08

(52) U.S. Cl. CPC F02B 67/06; B62M 27/02; F01L 1/022; F01M 1/02; F01P 5/12; F02B 33/40; F02B 63/042; F02N 11/08; F01M 2001/0269

(57) ABSTRACT

The present disclosure relates to an engine assembly for a vehicle. The engine assembly comprises an engine including an extended crankshaft with additional main bearings, an alternator or a generator, a drive chain assembly, and a starter motor assembly. The engine may be used in different models of the vehicle having different characteristics, which enables to interchange or replace an internal generator with an external alternator, and vice versa in addition enable to use a common starter motor assembly, crankshaft, crankcase, and drive chain assembly for both engine configuration without modifying a basic design of the engine. Further, placement of the starter motor assembly provides a compact arrangement. In addition, the extended crankshaft with the additional main bearings enables low noise level operation, avoids additional shafts and roller bearings to be attached, and cost effective. Similarly, the drive chain assembly produces less vibration and noise.

### PRIORITY CLAIM

This application claims the benefit of priority from U.S. Provisional Patent Application Nos. 63/545,106 filed Oct. 20, 2023; 63/544,072 filed Oct. 13, 2023; 63/542,865 filed Oct. 6, 2023; and 63/468,357 filed May 23, 2023, the contents of which are incorporated herein by reference.

### FIELD OF THE DISCLOSURE

The present disclosure generally relates to engines for off-road vehicles.

### BACKGROUND

An internal combustion (IC) engine generates mechanical energy through combustion of an air-fuel mixture, to drive moving parts of a vehicle, thereby enabling motion of the vehicle. Different vehicles have different types of IC engines, specifically, in terms of number of cylinders. For instance, off-road vehicles, such as, all-terrain vehicles (ATV) and side-by-side utility terrain vehicles (UTV or side-by-side) may have different engine designs and structures than those of snowmobiles. Furthermore, even within the various categories, some vehicles may be intended more for utility work whereas others may be intended mostly for sport. Other various purposes exist, such as, vehicles for youth or novice riders and vehicles for expert riders.

Typically, the internal combustion engine relies on a starter motor, a crankshaft, a drive chain, and an alternator or a generator for engine operation. When starting the vehicle, the starter motor turns the crankshaft, using electrical energy from a battery or using other motive force to turn the crankshaft and pistons, which initiates the compression and combustion process in cylinders. During the combustion process, the crankshaft converts a linear motion of pistons into a rotational motion, thereafter the rotational motion from the crankshaft is transmitted to a transmission assembly for driving the moving parts of the vehicle. During operation, the generator driven by the crankshaft, generates the electrical energy by converting the mechanical energy from the crankshaft into the electrical energy, which is then used to charge the battery and supply power to electrical systems including spark to the plug to initiate combustion. The drive chain may synchronize rotation of the crankshaft and camshaft for opening and closing of intake and exhaust valves during the combustion process.

Depending on a type of the vehicle, designs and structures of the engine may vary to suit the purposes and parameters of an intended vehicle. A snowmobile may have a different engine design and structure than that of a side-by-side vehicle. For instance, depending on the application, the engine may have either an internal generator or an external alternator. Typically, the internal generator is used where space is a constraint and power requirements might not be as high. The internal generator is positioned inside an engine compartment thereby offering compact design and better protection from harsh conditions. However, some vehicles may have an external alternator due to its easier accessibility, troubleshooting, customization options, greater power generation capability, and improved heat dissipation. Similar to the design and configuration of a starter motor or alternator assembly, the crankshaft and the drive chain also differ according to the application.

Conventional engines are designed for specific applications and specific operating conditions, which are generally neither adaptable nor upgradable for other applications and other operating conditions. For example, the engine is equipped with either the internal generator or the external alternator according to the application and the operating conditions. However, the engine with the internal generator may not be adaptable or interchangeable with the external alternator. Further, each engine configuration either with the internal generator or the external alternator may require a different starter motor assembly, and different crankshaft, which increases manufacturing cost, material cost, and adds operational complexity. Also, conventional starter motor assemblies consume larger spaces for assembly with the engine. Similarly, conventional crankshafts require additional components, such as separately attachable shafts and roller bearings, along with their respective seals to deal with a load of the transmission assembly driven by the crankshaft and for enabling low noise level operation. However, such crankshaft configurations lead to complexity in manufacturing as additional diameter may be needed to be concentric to main bearings and production costs increase.

### SUMMARY OF THE DISCLOSURE

In some embodiments, the present disclosure sets forth an engine with an extended crankshaft having an additional main bearing. The crankshaft is adaptable to different external alternators or internal generators while using the same starter motor assembly for any engine configuration. In addition to, or alternatively, the engine uses a silent drive chain assembly (i.e., inverted tooth chain). The engine design and components allow configuration modifications to adapt to differing off-road vehicles.

In some embodiments, the present disclosure sets forth an engine assembly of an off-road vehicle. The engine assembly includes an engine that is configured to generate power to move the vehicle. The engine includes a crankcase, a crankshaft housed in the crankcase, and a generator coupled to the crankshaft. The generator is selected from either an internal generator or an external alternator. The crankshaft is the same for the engine having any one of the internal generator or the external alternator.

The internal generator may comprise a flywheel and a stator. The flywheel is configured to be coupled to the crankshaft. The crankshaft is configured to rotate the flywheel for operating the internal generator. The external alternator may be coupled to the crankshaft using an external alternator assembly. The external alternator assembly includes a pulley and a belt. The pulley is configured to be secured on the crankshaft and is configured to be rotated corresponding to a rotation of the crankshaft. The belt is configured to transfer the rotation of the pulley to the external alternator for operating the external alternator.

In some embodiments, the engine extends from a first side to a second side of a central axis of the vehicle in a longitudinal direction of the vehicle. The first side of the central axis corresponds to a Power Take Off (PTO) side of the engine and is defined as a side of the engine with which a PTO shaft (e.g., crankshaft) is coupled for receiving power from the engine. The second side of the central axis corresponds to a non-PTO side of the engine that is opposite to the first side. The generator may be coupled to the crankshaft at the second side or the non-PTO side of the engine.

The engine may comprise a first cover or a second cover, according to a type of the generator coupled to the crankshaft, for attaching to the crankcase at the non-PTO side of the engine. The engine may comprise the first cover when the crankshaft is coupled to the internal generator or the second cover when the crankshaft is coupled to the external alternator. The first cover is configured to be secured to the crankcase at the non-PTO side in such a way to completely cover a second end of the crankshaft and the internal generator from an outside of the engine. The second end of the crankshaft corresponds to the second side or the non-PTO side of the engine. The second cover is configured to be secured to the crankcase at the non-PTO side where the crankshaft extends through an opening in the second cover to secure the pulley. Accordingly, the first cover completely covers the second end of the crankshaft end at the non-PTO side of the engine. The second cover enables the crankshaft to extend through the second cover, such that the second end of the crankshaft protrudes outside the second cover when the engine includes the external alternator.

In some embodiments, the engine with the internal generator is configured to have a first width Similarly, the engine with the external alternator is configured to have a second width. The first width of the engine with the internal generator is substantially same (e.g., within ten percent) as the second width of the engine with the external alternator, thereby a width of engine assembly is substantially same irrespective of the type of the generator is used.

The present disclosure further includes a starter motor assembly for an off-road vehicle. The starter motor assembly is configured to be attached to an engine of the vehicle. The starter motor assembly may be the same for the engine having any one of an internal generator or an external alternator.

In some embodiments, the starter motor assembly includes a gear assembly and a starter motor. The gear assembly may comprise a main gear coupled to a crankshaft, and at least one idler gear coupled to a drive gear of the stator motor. The main gear may be positioned behind a flywheel in case of the engine with the internal generator and behind a pulley in case of the engine with the external alternator. The starter motor may be positioned such that a longitudinal axis of the starter motor is parallel to a rotational axis of the crankshaft.

In some embodiments, the engine assembly comprises a crankshaft, a camshaft, and a drive chain assembly. The crankshaft extends from a first side to a second side of a longitudinal central axis of the vehicle. A second camshaft may be included. The drive chain assembly is located at the first side (i.e., PTO side) of the crankshaft. The drive chain assembly includes a timing chain and an auxiliary drive chain. The timing chain is configured for driving the camshaft corresponding to a rotation of the crankshaft. The auxiliary drive chain is configured for driving an oil pump. Each of the timing chain and the auxiliary drive chain is a silent chain. The timing chain is located after the auxiliary drive chain at a first end of the crankshaft from the first side or the PTO side of the engine.

In some embodiments, the engine assembly comprises a first main bearing and a second main bearing. The drive chain assembly is located between the first main bearing and the second main bearing. In some embodiments, the second main bearing is located at the first end of the crankshaft on the first side of the non-PTO side of the engine. Each of the first main bearing and the second main bearing is a plain bearing.

The crankshaft may be an extended crankshaft having an additional length and may be extended out of the crankcase on both sides. The crankshaft may be a single-piece crankshaft.

In some embodiments, the crankshaft is configured to be attached with a crankshaft extension for extending a distance between the engine and a continuous variable transmission (CVT) assembly on the PTO side. The crankshaft extension may be supported by a support bearing comprising a roller bearing. The crankshaft extension with respect to the support bearing may be covered or housed by a crankcase extension.

### BRIEF DESCRIPTION OF THE DRAWINGS

A more complete understanding of the present disclosure may be derived by referring to the detailed description and claims when considered in connection with the Figures, wherein like reference numerals refer to similar elements throughout the Figures.

FIGS. 1-2 illustrate exemplary side views of off-road vehicles.

FIGS. 3A-3C illustrate an exemplary views of an engine in vehicles, including a UTV vehicle (FIG. 3A) and a snowmobile (FIGS. 3B-C) in accordance with the present disclosure.

FIG. 4 illustrates an exemplary isometric view of an engine with an internal generator without a first cover in accordance with the present disclosure.

FIG. 5 illustrates an exemplary side-elevational view of an engine with an internal generator and a first cover housing the internal generator in accordance with the present disclosure.

FIG. 6 illustrates an exemplary partially exploded view of an engine with an internal generator and a starter motor assembly in accordance with the present disclosure.

FIG. 7 illustrates an exemplary cross-sectional view of an internal generator covered with a first cover in accordance with the present disclosure.

FIG. 8 illustrates an exemplary partial cross-sectional view of an engine with an internal generator covered with the first cover in accordance with the present disclosure.

FIG. 9 illustrates an exemplary side view of an engine with an external alternator and a second cover in accordance with the present disclosure.

FIG. 10 illustrates an exemplary partially exploded view of an engine with an external alternator and a starter motor assembly in accordance with the present disclosure.

FIG. 11 illustrates an exemplary cross-sectional view of a second cover of an engine with an external alternator in accordance with the present disclosure.

FIG. 12 illustrates an exemplary partial cross-sectional view of an engine with an external alternator and a second cover in accordance with the present disclosure.

FIG. 13 illustrates an isometric view of an engine with an external alternator and a compressor in accordance with the present disclosure.

FIG. 14 illustrates an exemplary enlarged isometric view of a starter motor assembly in accordance with the present disclosure.

FIG. 15 illustrates an exemplary side view of a starter motor attached to an engine in accordance with the present disclosure.

FIG. 16 illustrates an exemplary isometric view of an engine without outer portions showing a non-power take off (PTO) side of a crankshaft and associated components in accordance with the present disclosure.

FIG. 17 illustrates an exemplary side view of an engine with a drive chain assembly in accordance with the present disclosure.

FIG. 18 illustrates an exemplary side view of a drive chain assembly in accordance with the present disclosure.

FIG. 19 illustrates an exemplary side view of an auxiliary drive chain in accordance with the present disclosure.

FIG. 20 illustrates an exemplary isometric view of an engine without outer portions showing a power take off (PTO) side of a crankshaft and associated components in accordance with the present disclosure.

FIG. 21 illustrates an exemplary isometric view of a coolant pump entrained with an auxiliary drive chain in accordance with the present disclosure.

FIG. 22 illustrates an exemplary cross-sectional view of a crankcase housing a crankshaft and associated components in accordance with the present disclosure.

FIG. 23 illustrates an exemplary cut-out view of at least portion of a crankshaft showing an additional length to accommodate a second bearing in accordance with the present disclosure.

FIG. 24 illustrates an exemplary exploded view of a crankcase in accordance with the present disclosure.

FIG. 25 illustrates an exemplary exploded view of a multipiece crankshaft in accordance with the present disclosure.

FIG. 26 illustrates an exemplary cross-sectional view of an engine in accordance with the present disclosure.

FIG. 27 illustrates an exemplary isometric view of an engine assembly having a crankshaft with a crankshaft extension in accordance with the present disclosure.

FIG. 28 illustrates an exemplary cut-out view of at least portion of a crankshaft coupled with a crankshaft extension in accordance with the present disclosure.

FIG. 29 illustrates an exemplary cross-sectional view of a crankcase extension accommodated a crankshaft extension in accordance with the present disclosure.

FIGS. 30A-30C illustrate exemplary partial cross-sectional views of a crankcase and crankshaft extension in accordance with the present disclosure.

FIG. 31 illustrates an exemplary partial cross-sectional view of a single piece crankshaft attached with a flywheel in accordance with the present disclosure.

FIG. 32 illustrates an exemplary top view of an engine with a crankshaft extension, mounted in a wide track snowmobile in accordance with the present disclosure.

### DETAILED DESCRIPTION

The following description sets forth exemplary embodiments of the invention only, and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms, and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Embodiments of the present disclosure describe an engine assembly, and a vehicle having the engine assembly. The term ‘engine assembly’ used throughout the disclosure may comprise an engine having a crankshaft, an alternator or a generator, a compressor, camshafts, a drive chain assembly, a starter motor assembly, and other associated parts known to a person skilled in the art. The engine may be an internal combustion (IC) engine (or ICE). Components described herein may be utilized for different vehicles such as on-road vehicles and off-road vehicles. For example, the engine of the present disclosure may be used in different models of the vehicle having different characteristics, which enables one to interchange or replace an internal generator with an external alternator, and vice versa. In addition, the engine of the present disclosure enables engineers to use the same starter motor assembly, crankshaft, and drive chain assembly for any engine configuration having either the internal generator or the external alternator without modifying a basic design of the engine. Accordingly, the number of engine components to be replaced or modified are reduced (i.e., maximizing common components) while adapting the engine to different vehicles and/or applications. Further, placement of the starter motor assembly of the present disclosure provides a compact arrangement with the engine irrespective of use of the internal generator or the external alternator, thereby keeping the space envelope to minimum. In addition, the crankshaft of the present disclosure enables low noise level operation, avoids additional shafts and roller bearings to be attached, and is cost effective Similarly, the drive chain assembly of the present disclosure produces less vibration and noise.

The disclosures of the following applications are hereby incorporated by reference: application Ser. No. 18/650,021, filed Apr. 29, 2024; application Ser. No. 18/649,993, filed Apr. 29, 2024; application Ser. No. 18/651,652, filed Apr. 30, 2024; Application Ser. No. 63/537,179, filed Sep. 7, 2023; Application Ser. No. 63/543,461, filed Oct. 10, 2023; and Application Ser. No. 63/528,411, filed Jul. 23, 2023.

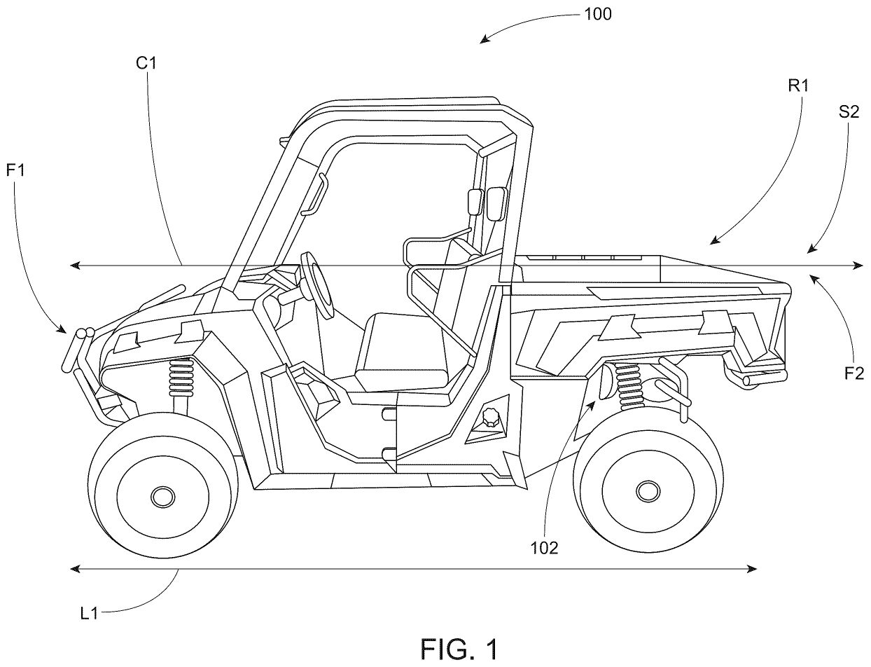

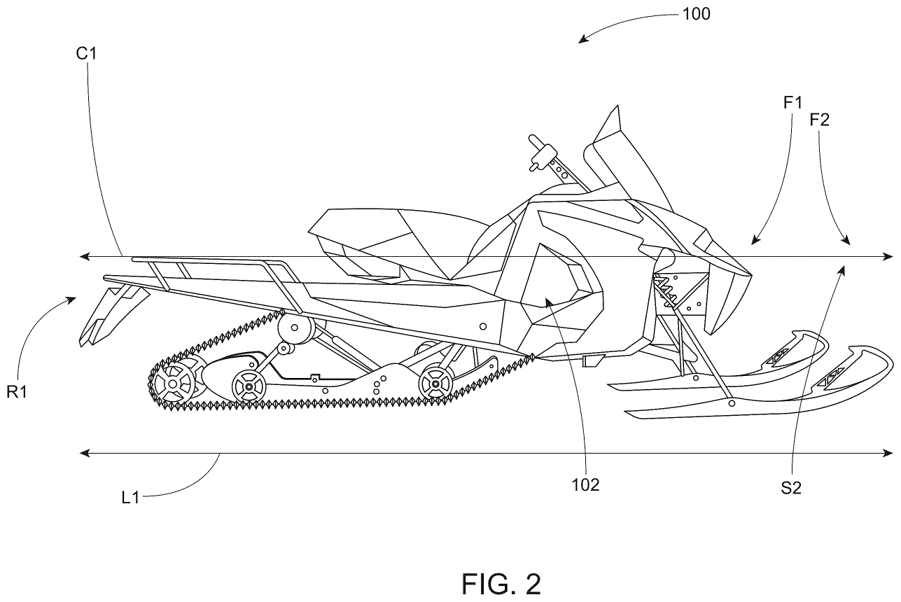

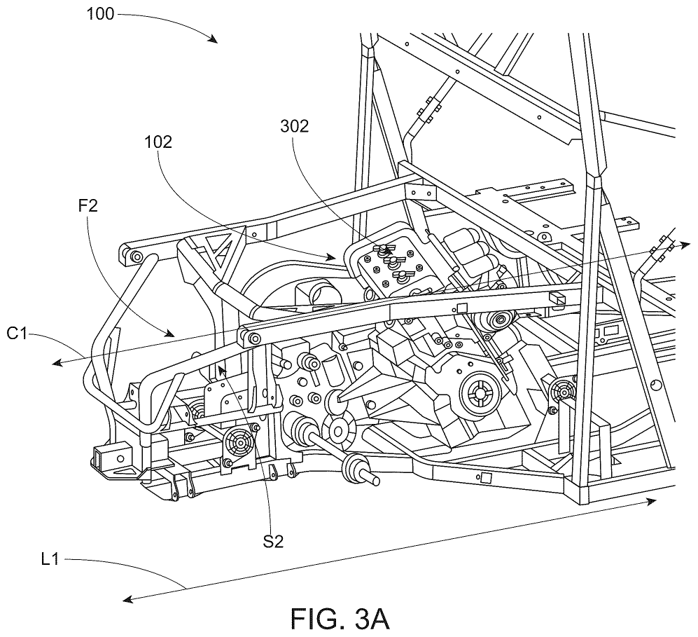

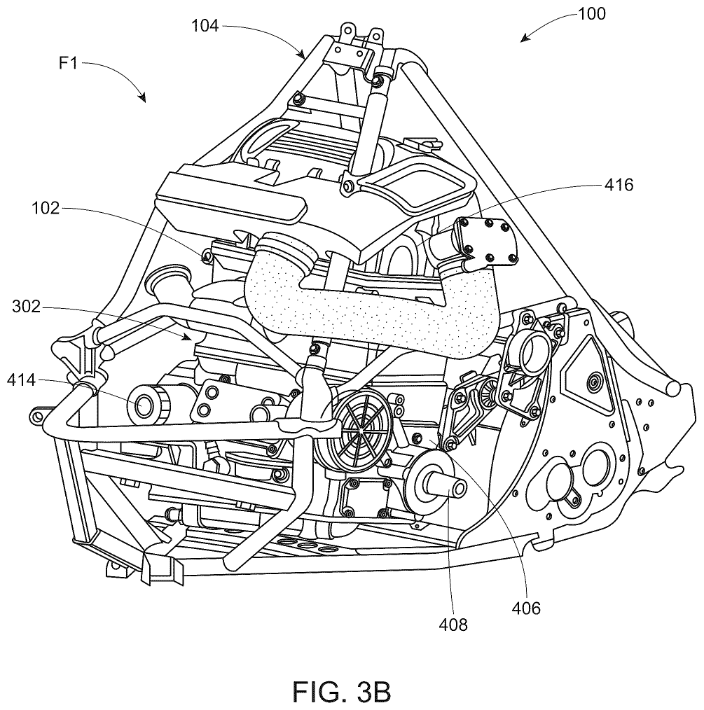

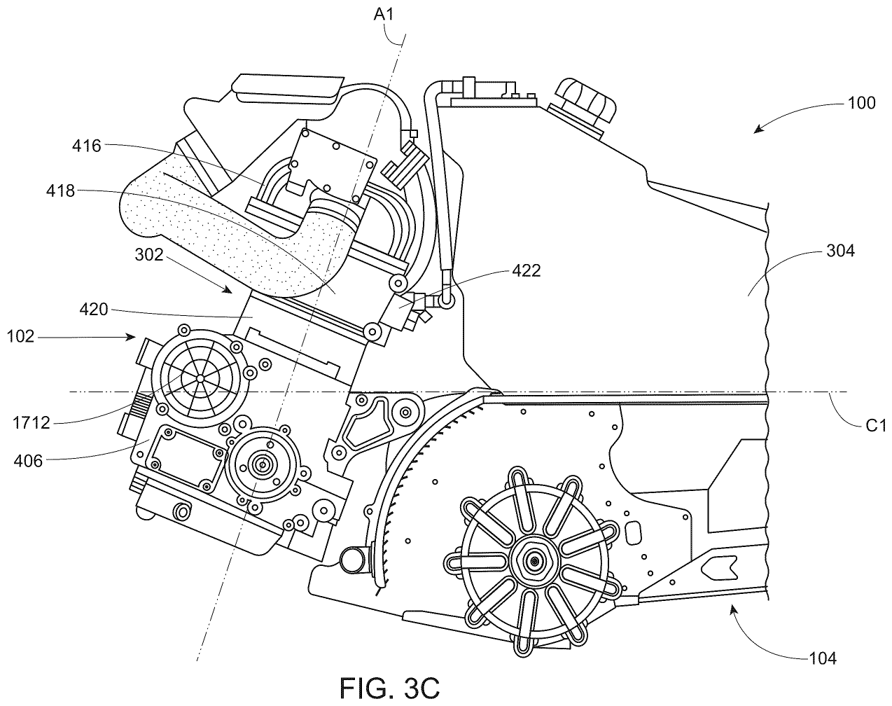

Reference is now made to FIGS. 1-3, which illustrate off-road vehicles, such as, a side-by-side vehicle and a snowmobile, each with an engine assembly 102 in accordance with the present disclosure. It is to be noted that the present disclosure relates to engine assemblies of off-road vehicles, represented as 100. Accordingly, the reference numeral 100 generally represents an off-road vehicle. A portion of a UTV that holds the engine assembly 102 is shown, for example, in FIG. 3A. In this view, the vehicle 100 extends from a front end (F1) to a rear end (R1) in a longitudinal direction (L1) of the vehicle 100 and has a central axis (C1) extending in the longitudinal direction (L1) and passing through a center of the vehicle 100. The central axis (C1) comprises a first side (F2) and a second side (S2). In other words, the central axis (C1) extends from the front end (F1) to the rear end (R1) of the vehicle 100 and divides the vehicle 100 into two parts namely left part and right part. The first side (F2) of the central axis (C1) corresponds to a left side of the vehicle 100 when viewed from the rear end (R1) of the vehicle 100. The second side (S2) of the central axis (C1) corresponds to a right side of the vehicle 100 when viewed from the rear end (R1) of the vehicle 100. The vehicle 100 generally comprises an engine assembly 102 (seen e.g., in FIGS. 3A-C) and other components.

FIGS. 3B and 3C illustrate an engine assembly 102 situated within a chassis 104 of a snowmobile 100. The front chassis 104 with engine 302 is shown in FIG. 3B. Various of the engine components are numbered consistent with the numbers shown in the other figures and discussed below. The side-elevational view of FIG. 3C shows the engine assembly 102 positioned in front of the fuel tank 304 and tunnel portion of the chassis 104. Note that the engine 302 preferably is tilted rearwardly at an angle A1. In this view (FIG. 3C), the forward frame portion of the chassis from FIG. 3B is not shown.

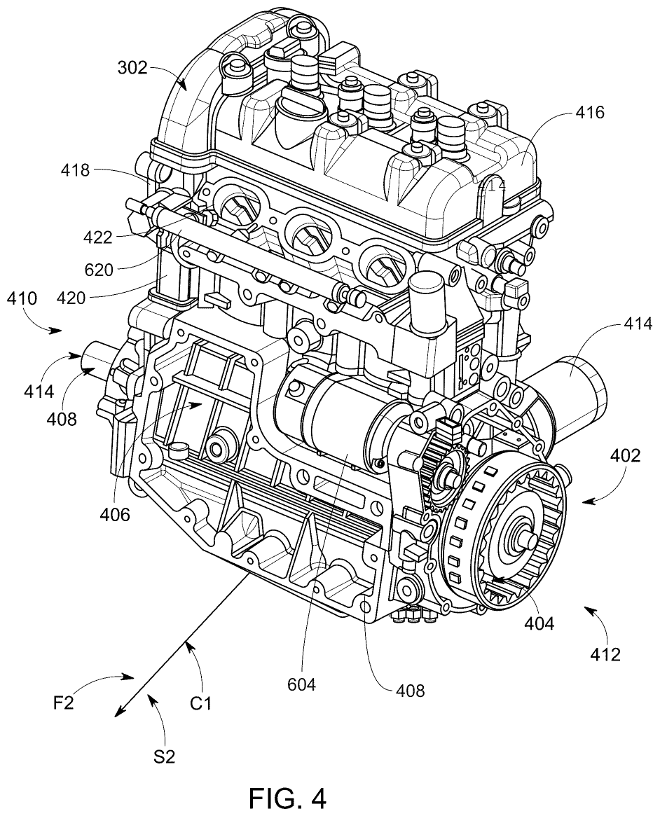

The engine assembly 102 facilitates translation of combustion energy or thermal energy to rotational energy for enabling movement of the vehicle 100 and further translate the rotational energy into electrical energy that is stored in a power storage system and is used to power electrical systems including a spark plug to initiate combustion in the vehicle 100. The engine assembly 102 comprises an engine 302 for generating power to move the vehicle 100. Preferred examples include a four-stroke, three-cylinder engine. The engine 302 includes a crankcase 406, a crankshaft 408 housed in the crankcase 406, a cylinder block 420, a head 418 having intake ports 422 and exhaust ports 504, a fuel rail 620, a valve cover 416, an oil filter 414, a generator 402 coupled to the crankshaft 408, a starter motor assembly 602 with a starter motor 604, an oil sump 914, and a drive chain assembly 1702 (seen e.g., in FIGS. 4, 6, 9, 14, and 17).

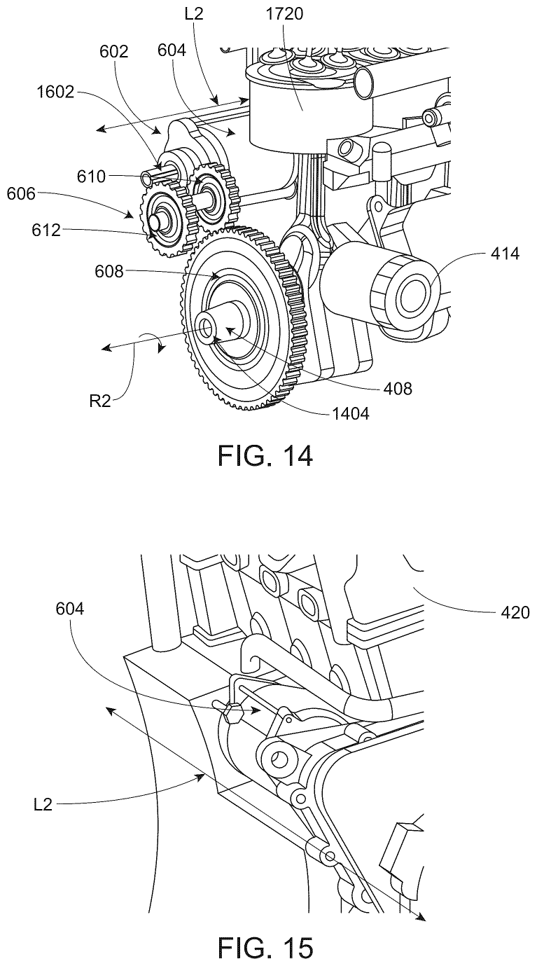

The engine 302 extends from the first side (F2) to the second side (S2) of the central axis (C1) of the vehicle 100. It is to be noted that the first side (F2) and the second side (S2) represent the sides that extend in a direction lateral to the longitudinal direction (L1). Similarly, the crankshaft 408 extends from the first side (F2) to the second side (S2) of the central axis (C1) of the vehicle 100. In other words, the crankshaft 408 extends between a first end 414 and a second end 1404 of the crankshaft 408 (seen FIGS. 4 and 14). The first end 414 of the crankshaft 408 corresponds to the first side (F2). The second end 1404 of the crankshaft 408 corresponds to the second side (S2). The first side (F2) corresponds to a Power Take Off (PTO) side 410 of the engine 302 and is defined as a side of the engine 302 with which a PTO shaft (e.g., crankshaft 408) is coupled for receiving power from the engine 302. The second side (S2) corresponds to a non-PTO side 412 of the engine 302 that is opposite to the first side (F2) (seen e.g., in FIG. 4).

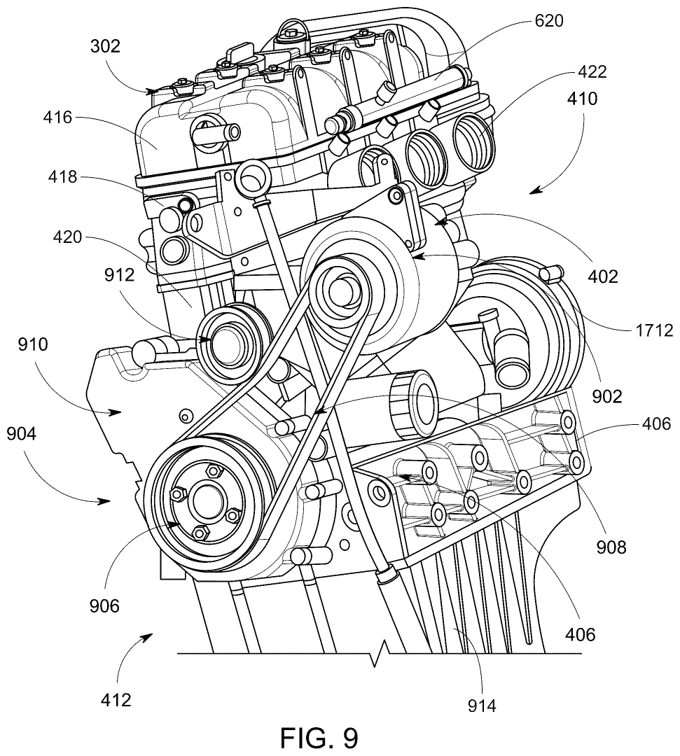

It is to be noted that the generator 402 is coupled to the crankshaft 408 at the second side (S2). Accordingly, the generator 402 is coupled with the crankshaft 408 at the non-PTO side 412 of the crankshaft 408 or the engine 302 (seen e.g., in FIG. 4). The generator 402 is configured to convert mechanical energy such as rotational energy from the crankshaft 408 into electrical energy which is used to power the electrical systems of the vehicle 100 and stored in the power storage system. The engine 302 is configured to accommodate an internal generator 404 or an external alternator 902 (seen e.g., in FIGS. 4 and 9). In a non-limiting example, the crankshaft 408 is the same for the engine 302 having any one of the internal generator 404 or the external alternator 902. Similarly, the crankcase 406 may be the same for the engine 302 having the internal generator 404 and the engine having the external alternator 902.

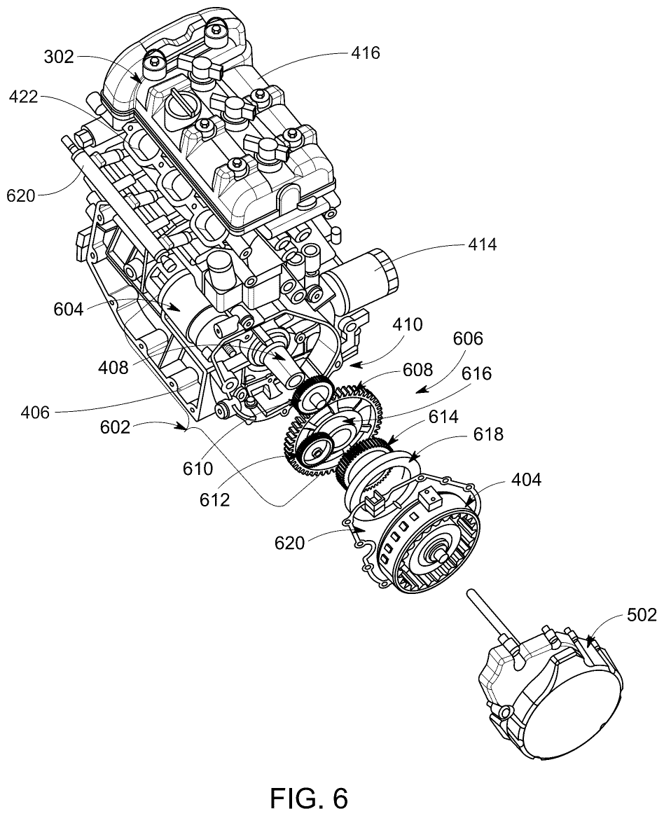

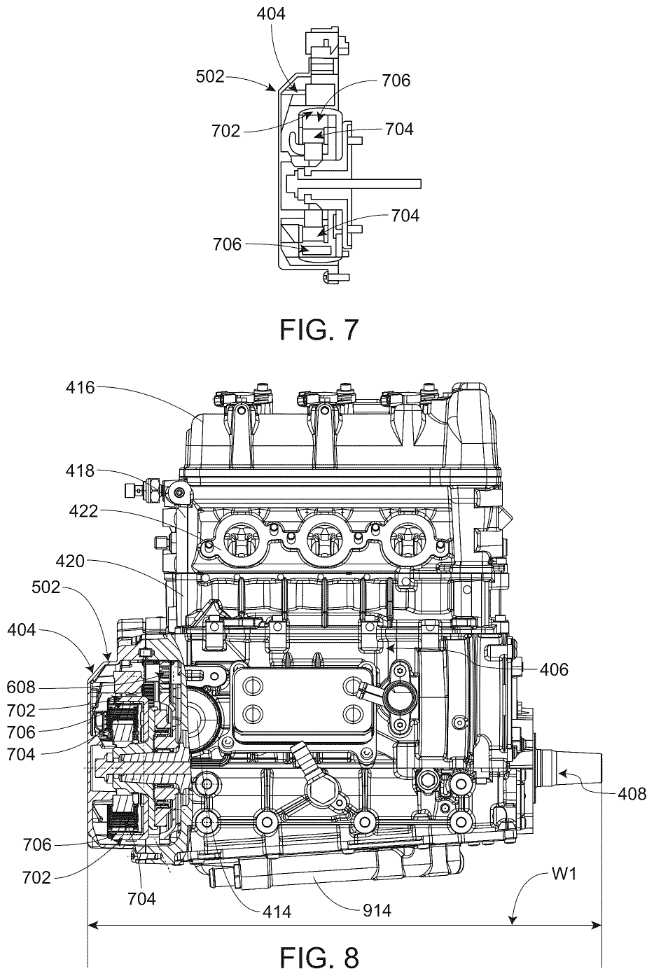

While using the internal generator 404, the internal generator 404 is configured to couple with the crankshaft 408 at the second side (S2) or the non-PTO side 412 of the engine 302 (seen e.g., in FIGS. 4 and 6). The internal generator 404 comprises a flywheel 702 fitted over the crankshaft 408, a plurality of magnets 706 positioned on an inner circumference of the flywheel 702, a stator 704 having electric power generating coils disposed radially inward of the plurality of magnets 706 (seen e.g., in FIG. 7). The plurality of magnets 706 may be permanent magnets. The crankshaft 408 rotates the flywheel 702 for operating the internal generator 404. As the flywheel 702 rotates, the plurality of magnets 706 rotate along with the flywheel 702 and create a magnetic field that induces an alternating current (AC) in the electric power generating coils of the stator 704 through electromagnetic induction. Thereafter, the alternating current (AC) from the electric power generating coils is rectified and stored in the power storage system and/or used to power the electrical systems including a spark plug to initiate the combustion process.

In some embodiments, the engine 302 may further comprise a first timing wheel fitted with the internal generator 404. A first timing sensor may be mounted near the first timing wheel. The first timing wheel rotates along with the flywheel 702 when the crankshaft 408 is rotated. The notches or teeth on the first timing wheel pass by the first timing sensor, provides information regarding crankshaft position and speed for precise ignition timing.

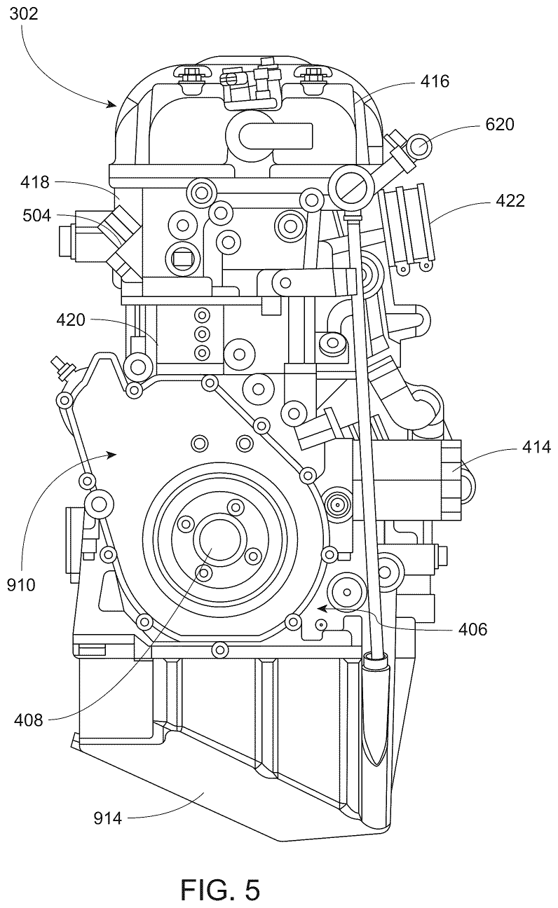

In some embodiments, the engine 302 comprises a first cover 502 for covering or housing the internal generator 404 when the engine 302 includes the internal generator 404 (seen e.g., in FIGS. 5 and 6). The first cover 502 is configured to be attached to the crankcase 406, on the second side (S2) of the engine 302, to house the internal generator 404 as well as the second end 1404 of the crankshaft 408. The first cover 502 covers the internal generator 404 and the second end 1404 of the crankshaft 408 by fastening with the crankcase 406 using removable fasteners. The engine 302 further comprises a first gasket 620 that is placed between the crankcase 406 and the first cover 502 for providing sealing between the crankcase 406 and the first cover 502 (seen e.g., in FIG. 6). FIG. 8 illustrates an exemplary partial cross-sectional of the internal generator 404 attached to the crankshaft 408 and having the first cover 502 attached to the crankcase 406.

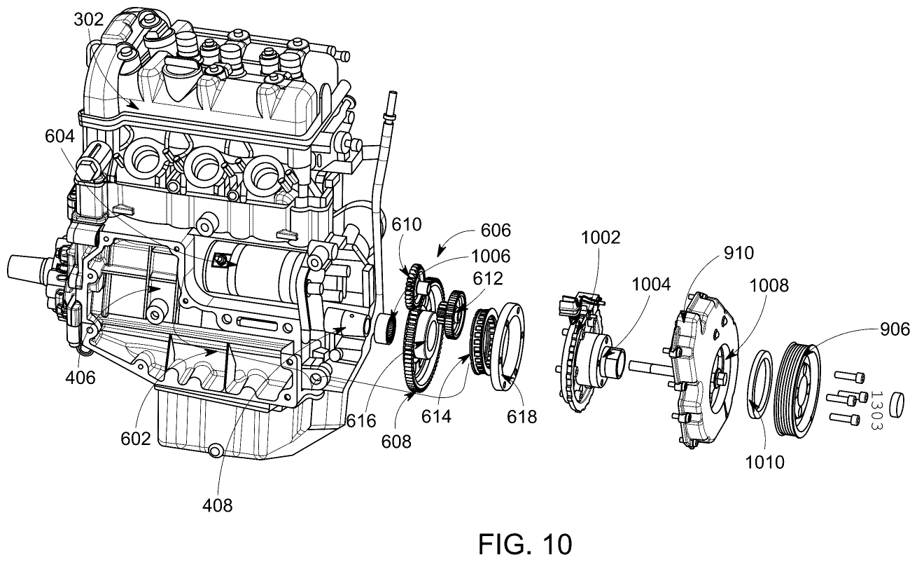

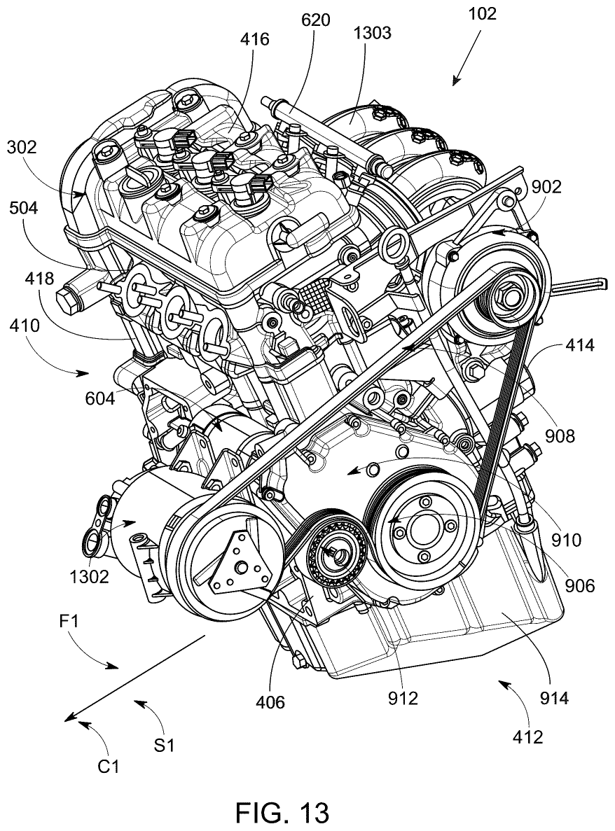

In some embodiments, the engine 302 is configured to work with the external alternator 902. In such case, the external alternator 902 is configured to be coupled with the crankshaft 408 at the second side (S2) or the non-PTO side 412 of the engine 302 (seen e.g., in FIGS. 9 and 10). The external alternator 902 may be used in the engine 302 due to amperage requirements. The external alternator 902 is coupled to the crankshaft 408 using an external alternator assembly 904. The external alternator assembly 904 comprises a pulley 906 and a belt 908 (seen e.g., in FIG. 9). The pulley 906 is configured to be secured on the crankshaft 408 at the second side (S2) or the non-PTO side 412 and is configured to be rotated corresponding to a rotation of the crankshaft 408. In other words, the pulley 906 is secured to the second end 1404 of the crankshaft 408. The pulley 906 is entrained with the belt 908 to drive the external alternator 902. The belt 908 is further configured to transfer the rotation of the pulley 906 to the external alternator 902 for operating the external alternator 902. The belt 908 may be a serpentine belt or a V-belt. The engine 302 may comprise an idler wheel or an idler pulley 912 (seen e.g., in FIGS. 9 and 13) for tensioning the belt 908 and guiding the belt 908 between the pulley 906 and the external alternator 902, thereby preventing slip of the belt 908, reducing noise, vibration, and harness (NVH) of the external alternator 902 and improving longevity of the belt 908. The engine 302 may further comprise an intermediate plate 1010 for facilitating attachment of the pulley 906 on the crankshaft 408, thereby enabling secure attachment of the pulley 906 on the crankshaft 408 (seen e.g., in FIG. 10).

The external alternator 902 may comprise a rotor and a stator (not shown) for generating the electrical energy from mechanical energy from the crankshaft 408. Preferably, the external alternator 902 is located on the forward side of the engine assembly 102 adjacent and partially to the side of the intake manifold 1303. It may also be above the oil filter 414. This provides good packaging as the alternator may sit in a space created by the other components. It also provides belt alignment and space for other components that may be used and entrained in the belt such as the compressor 1302. See FIG. 13.

The stator may comprise a stator core and stator windings. The rotor may comprise a rotor core and rotor windings or field coil around the rotor core. The rotor may comprise permanent magnets instead of the rotor windings. The rotor may be placed inside the stator core. The crankshaft 408 rotates the rotor along with the permanent magnets that in turn creates a magnetic field. In the case of the field coil (i.e., electromagnet), a small amount of current from the power storage system is used to energize the field coil, thus creating the magnetic field. Thereafter, created magnetic field induces an alternating current (AC) in the stator windings of the stator through electromagnetic induction. Thereafter, the alternating current (AC) from the stator windings is rectified and stored in the power storage system and/or used to power the electrical systems including a spark plug to initiate the combustion process.

In some embodiments, the engine 302 may comprise a second timing wheel 1002 along with a hub 1004 for facilitating attachment of the pulley 906 on the crankshaft 408 (seen e.g., in FIG. 10). A second timing sensor (not shown) may be mounted near the second timing wheel 1002. The second timing wheel 1002 rotates along with pulley 906 when the crankshaft 408 is rotated. The notches or teeth on the second timing wheel 1002 pass by the second timing sensor, provides information regarding crankshaft position and speed for precise ignition timing.

The engine 302 may comprise a second cover 910 that is configured to be attached to the crankcase 406 when the engine 302 including the external alternator 902 (seen e.g., in FIGS. 9 and 13). The second cover 910 is configured to be attached to the crankcase 406, on the second side (S2) or the non-PTO side 412 of the engine 302. The second cover 910 comprises an opening 1008 for passing the crankshaft 408 therewithin to secure the pulley 906 over the crankshaft 408. The pulley 906 is secured outside the second cover 910. The second cover 910 is fastened with the crankcase 406 using removable fasteners. The engine 302 further comprises a second gasket (not shown) that is placed between the crankcase 406 and the second cover 910 for providing sealing between the crankcase 406 and the second cover 910. In an illustrative example, the first cover 502 and second cover 910 are different. The second cover 910 may be small when compared to the first cover 502. The second cover 910 allows the second end 1404 of the crankshaft 408 to extend through and protrude outside therefrom. The first cover 502 may be large, thereby completely covering the second end 1404 of the crankshaft 408 including the internal generator 404. While adapting to the internal generator 404 or the external alternator 902, a cover of the generator 402 is exchanged according to the alternator or generator 402 options at the second side (S2) of the crankshaft 408. FIG. 12 illustrates an exemplary partial cross-sectional view of the engine 302 with the external alternator 902 attached to the crankshaft 408 and having the second cover 910 attached to the crankcase 406.

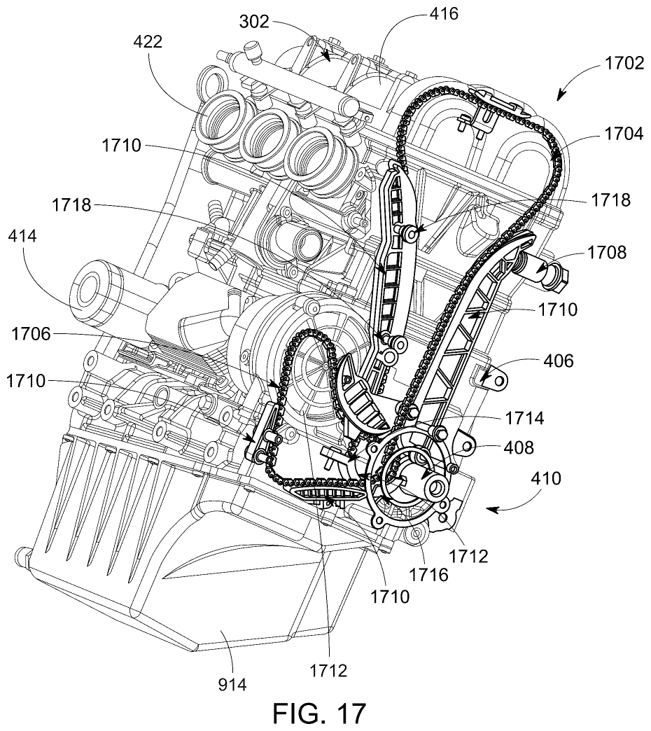

It is to be noted that the engine 302 is configured to have a width. It is to be noted that the width of the engine 302 is measured laterally from the first side (F2) to the second side (S2) of the engine 302 including all engine components, and vice versa. In other words, the width of the engine 302 is measured laterally from the PTO side 410 to the non-PTO side 412 of the engine 302 including all engine components, and vice versa. The width of the engine 302 is an important parameter in engine design as it influences an arrangement of other components surrounding the engine 302. The dimensions, such as the width, of the engine 302 and the other parameters need to be kept while designing, such that the engine assembly 102 fits into a specific space allotted thereto. The length (preferably positioned width wise in the vehicle) of the crankshaft can be important in keeping the overall width of the engine assembly 102 to a minimum. The various engine components are driven by the crankshaft including the alternator 902, the compressor 1302, the timing chain 1404, and the auxiliary chain drive 1406. See FIGS. 13 and 17, for example showing the belt driven components and the chain driven components, respectively. The allotted space plays a significant role in design of the vehicle 100, as the placement and the space envelope of the engine 302 contributes to the overall dimension of the vehicle 100.

In that respect, the engine 302 with the internal generator 404 is configured to have a first width (W1) (seen e.g., in FIG. 8) and the engine 302 with the external alternator 902 is configured to have a second width (W2) (seen e.g., in FIG. 12). The configuration from FIG. 8 with the internal generator 404 is the type preferably used with a snowmobile, the crankshaft essentially making up most of width W1. The configuration from FIG. 12 with the external alternator 902 is the type preferably used with an off-road UTV-type vehicle where the space constraints may be different. However, note that the first width (W1) of the engine 302 with the internal generator 404 is substantially same as the second width (W2) of the engine 302 with the external alternator 902. The pulley 906 in FIG. 12 takes up approximately the extra space required for the internal generator 404 in FIG. 8 such that the same or similar length crankshaft may be used while the engine widths are the same or similar. Hence, the engine 302 may be used with either the internal generator 404 or the external alternator 902 without significantly affecting overall design of the engine assembly 102 or without significantly adapting the vehicle into which the engine 302 is to be inserted.

Alternatively, the engine width (W1, W2) can be measured from the side of the crankcase 406 (at the PTO side of the engine) instead of from the end of the crankshaft 408. The crankshaft length or extension may vary depending on drive system requirements. However, the kay aspect to note here is that the space envelope of the engine is similar with either the internal generator 404 and cover 502 (FIG. 8) and with the engine having the external alternator with pulley 906 (FIG. 12).

In some embodiments, the engine 302 may further comprise a compressor 1302 that is coupled with the engine 302 via the external alternator assembly 904 (seen e.g., in FIG. 13). The belt 908 of the external alternator assembly 904 is configured to couple the compressor 1302 to the pulley 906 secured on the crankshaft 408 and operate the compressor 1302 according to a rotation of the crankshaft 408. As the crankshaft 408 rotates the pulley 906, the belt 908 transfers the rotation to drive or power the compressor 1302. The compressor 1302 may be an air conditioning (AC) compressor that is configured to compress refrigerant gas, which facilitates transfer of heat from a vehicle cabin to an outside environment, thereby cooling inside the vehicle 100. The compressor 1302 may be positioned at 120 degrees with respect to an orientation of the pulley 906 when viewed from the right side of the vehicle 100. The idler wheel 912 may be further configured to guide the belt 908 between the pulley 906, the external alternator 902, and the compressor 1302 (seen e.g., in FIG. 13). It is to be noted that a location of the idler wheel 912 with respect to the engine 302 may be changed based on engine configuration with or without the compressor 1302. In this preferred embodiment, the alternator 902 is adjacent an air intake manifold 1303.

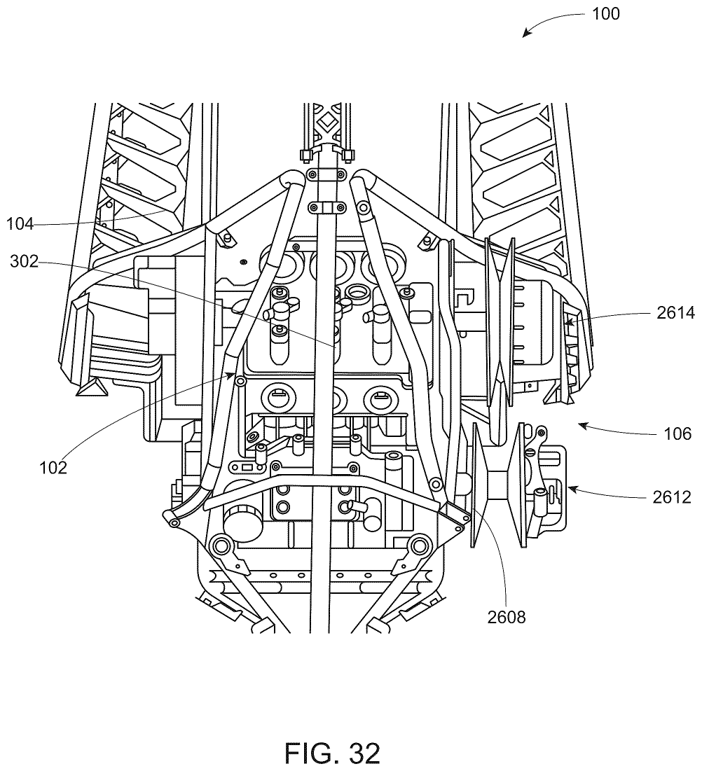

In some embodiments, the crankshaft 408 is coupled with a continuous variable transmission (CVT) 106 for transferring the rotational inertia from the engine 302 to drive wheels of the vehicle 100 (seen e.g., in FIG. 32). The continuous variable transmission (CVT) comprises a CVT clutch sheeves 2608 configured to be rotated corresponding to the rotation of the crankshaft 408. In some embodiments, the CVT sheeves 2608 having a width that is same for the engine 302 having any one of the internal generator 404 or the external alternator 902. The transverse configuration of the crankshaft in the vehicle facilitates preferred arrangement of the CVT at the end of the crankshaft and to drive the snowmobile track shaft (not shown). This configuration also allows the center of gravity of the engine to be positioned rearward toward the snowmobile tunnel and rider to centralize the mass for optimal vehicle handling. The triangulated frame structure of the chassis over this engine configuration optimizes the strength of the chassis for its weight.

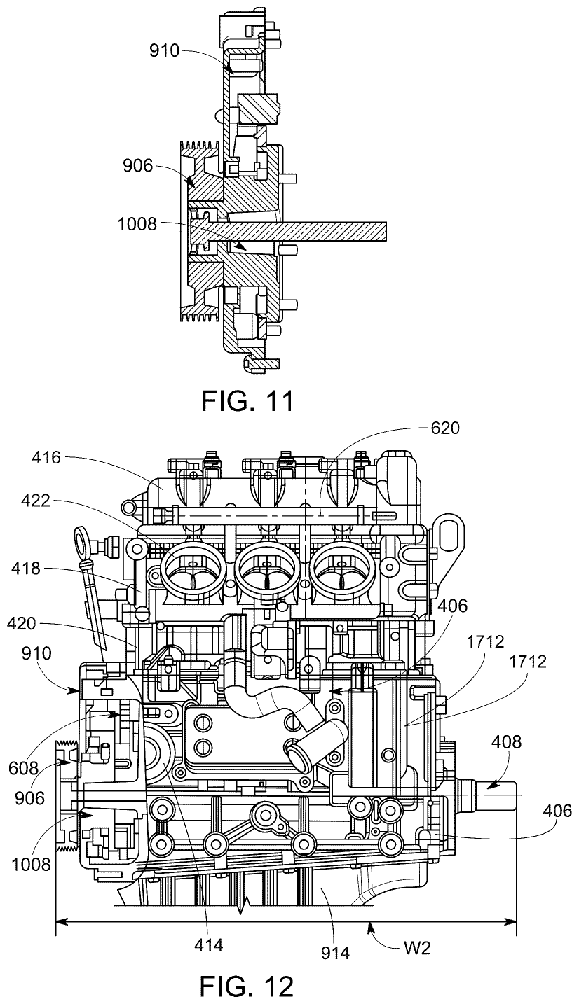

With reference to FIGS. 6-16, the engine 302 comprises a starter motor assembly 602 that is configured for transmitting rotational power to the crankshaft 408 for initiating combustion process. The starter motor assembly 602 is the same for the engine 302 having any one of the internal generator 404 or the external alternator 902. Accordingly, the engine 302 of the present disclosure is adaptable to both engine configurations having either the internal generator 404 or the external alternator 902 while having a common crankcase 406, crankshaft 408, and starter motor assembly 602.

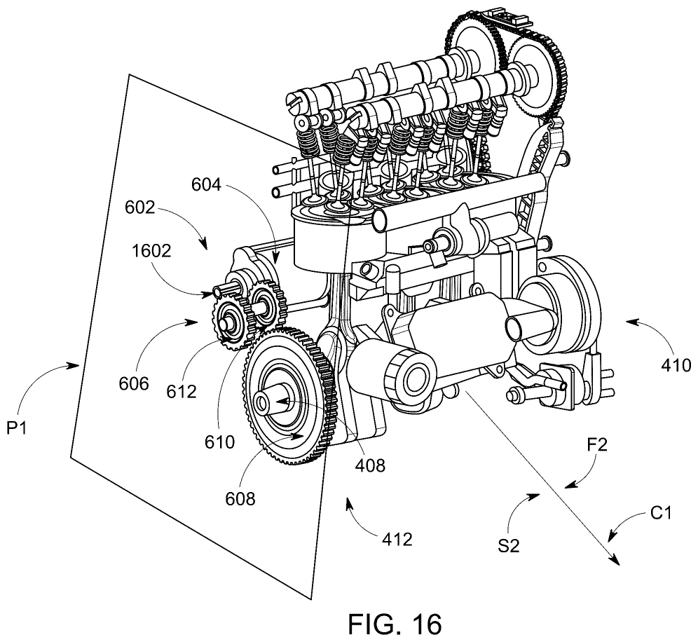

The starter motor assembly 602 comprises a starter motor 604 and a gear assembly 606. The crankshaft 408 is configured to be coupled to the starter motor 604 via the gear assembly 606. The starter motor 604 may be an electric motor. The starter motor 604 is positioned such that a longitudinal axis (L2) of the starter motor 604 is parallel to a rotational axis (R2) of the crankshaft 408 (seen e.g., in FIG. 14). The longitudinal axis (L2) of the starter motor 604 extends from the left side to right side of the vehicle 100, and vice versa. Such that, the starter motor 604 is positioned inward to a side plane (P1) of the generator 402 (seen e.g., in FIG. 16). The side plane (P1) of the generator 402 being defined as a plane passing through the second side (S2) of the engine 302. Accordingly, the starter motor 604 is positioned on a rear side of the engine 302 where the starter motor 604 extends parallel to the crankshaft 408 alongside cylinders. Accordingly, the rotational axis of the starter motor 604 is positioned rearward of and parallel to the rotational axis (R1) of the crankshaft 408. In the preferred engine configuration for the snowmobile, the air intake ports 422 are on the rear of the engine assembly 102 as shown, for example, in FIGS. 4, 6, 8, 15, 27, and 32. In this configuration, the starter motor 604 is positioned on below the air intake manifold and fuel rail. In the case of the preferred engine assembly 102 for the UTV, for example in FIGS. 3, 5, 9, 10, 12, 13, 16, and 17, the starter motor 604 is positioned below the exhaust ports 504 and exhaust manifold. In either configuration, the stator motor is preferably nested against the crankcase and entrained with the auxiliary chain drive. The rear side of the engine 302 corresponds to a side of the engine 302 towards the rear end (R1) of the vehicle 100.

Preferably, the gear assembly 606 is essentially the same for the engine configuration having the internal generator (preferred for snowmobile) and that having the external alternator (preferred for UTV). FIG. 6 shows the gear assembly 606 for the engine with the rearward air intake 422 and the internal generator (e.g., snowmobile). FIG. 10 shows a similar gear assembly 606 for the engine with the forward air intake and the external alternator (e.g., UTV). The gear assembly 606 comprises a main gear or a starter gear 608 coupled or positioned on the crankshaft 408, at least one idler gear 610 coupled to a drive gear 1602 of the stator motor 604, and a reduction gear set 612 coupled to the at least one idler gear 610 (seen e.g., in FIGS. 6, 10, and 14). The main gear 608 is coupled to the crankshaft 408 using a needle bearing 1006 (FIG. 10). The reduction gear set 612 may comprise one or more gears for reducing speed of the rotation. The gear assembly 606 is positioned inboard of the pulley 906 in case of the engine 302 having the external alternator 902.In the case of the engine assembly currently preferred for the snowmobile (FIG. 6), the gear assembly 606 is positioned inboard of the flywheel 702 and the stator 704, between the crankcase and the flywheel (see FIG. 8) in case of the engine 302 having the internal generator 404. More particularly, the main gear 608 is positioned behind the flywheel 702 where the engine 302 having the internal generator 404 Similarly, for the engine with the external alternator (FIG. 10) the main gear 608 is positioned behind the pulley 906 where the engine 302 having the external alternator 902. Such arrangement of the starter motor 604 and gear assembly 606 provides a compact arrangement of the starter motor assembly 602 with the engine 302 that keeps a space envelope to minimum (seen e.g., in FIG. 15). As seen FIG. 15, the starter motor assembly 602 is tucked or inserted next to the engine 302 which offers compact arrangement.

When the vehicle 100 is started, the starter motor 604 is configured to generate mechanical energy such as the rotational power by using the electrical energy from the power storage system. The gear assembly 606 is configured to transmit the rotational power from the starter motor 604 to the crankshaft 408. The starter motor 604 rotates the drive gear 1602 which in turn rotates or drives the at least one idler gear 610. Then, the at least one idler gear 610 transfers a rotation to the reduction gear set 612. The reduction gear set 612 reduces speed of the rotation from the starter motor and increase the torque that is necessary to initiate the air/fuel compression and combustion process. The reduction gear set 612 further drives the main gear 608 that is secured on the crankshaft 408.

In some embodiments, the engine 302 comprises an overrun clutch assembly attached to the main gear 608. The overrun clutch assembly comprises an overrun clutch 614, an inner ring member 616 coupled with the main gear 608, and an outer ring member 618 (seen e.g., in FIG. 6). The inner ring member 616 is directly coupled with the main gear 608. After increasing the torque, the reduction gear set 612 transfers the rotation to the inner ring member 616. The inner ring member 616 transfers the rotation to the outer ring member 618, which in turn drives the main gear 608. The main gear 608 finally drives or rotates the crankshaft 408. Once the engine 302 is started, the overrun clutch assembly enables the main gear 608 to drive the generator 402 by transferring the rotation of the crankshaft 408 via the outer ring member 618 to the generator 402. For the engine 302 with the internal alternator 404, the overrun clutch assembly enables rotation of the flywheel 702 by transferring the rotation of the crankshaft 408 via the outer ring member 618 to the flywheel 702. In the engine 302 with the external alternator 902, the overrun clutch assembly enables rotation of the pulley 906 by transferring the rotation of the crankshaft 408 via the outer ring member 618 to the pulley 906. However, if the generator 402 starts to rotate faster than the main gear 608, the overrun clutch disengages and prevents the generator 402 from driving the engine 302.

The cover of the generator 402 is configured to cover the outboard end of the starter motor 604 of the vehicle 100 at the second side (S2) of the engine 302. While the engine 302 comprises the internal alternator 404, the first cover 502 is configured to cover, at least partially, the starter motor 604 at the second side (S2) of the engine 302 (seen e.g., in FIGS. 6, 7, and 8). While the engine 302 comprises the external alternator 902, the second cover 910 is configured to cover, at least partially, the starter motor 604 at the second side (S2) of the engine 302 (seen e.g., in FIG. 13).

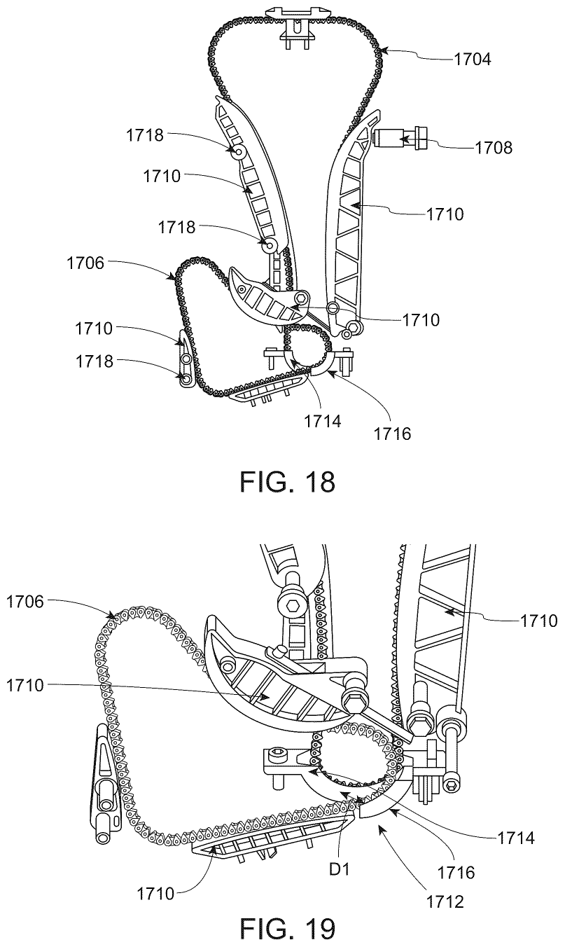

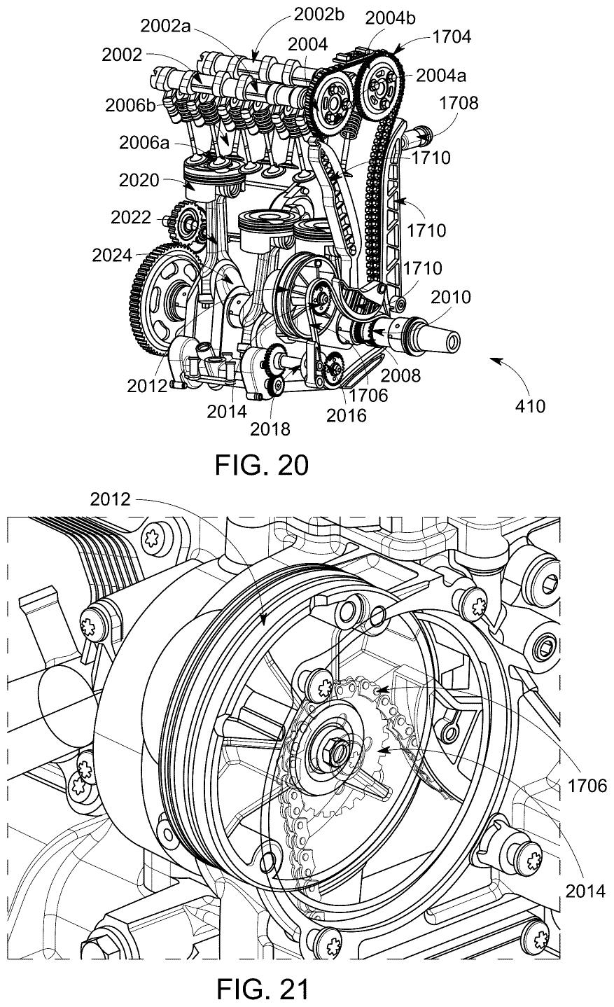

Reference is now made to FIGS. 17-22, which refer to the PTO side 410 of the engine 302. The engine 302 may include a plurality of drive chains for providing rotational movement to different components attached thereto. The engine 302 assembly includes a drive chain assembly 1702. The drive chain assembly 1702 includes a timing chain 1704 configured to couple the crankshaft 408 with at least one camshaft 2002 (seen e.g., in FIGS. 17 and 20). The drive chain assembly 1702 may further include an auxiliary drive chain 1706 configured for operating an oil pump 2018 and/or a coolant pump 2012. Each of the timing chain 1704 and the auxiliary drive chain 1706 is configured to be a silent chain.

It is to be noted that the silent chains use specific sprockets having teeth for engaging therewith. Such silent chains may be the type with inverted teeth engaging the gear teeth, one of such offered by Morse chains. The silent chains engage with the teeth with little impact or sliding. Such engagement results in reduced noise, vibration, and harshness (NVH) of the vehicle 100. This ensures smoother operation of the engine 302 having such silent chains.

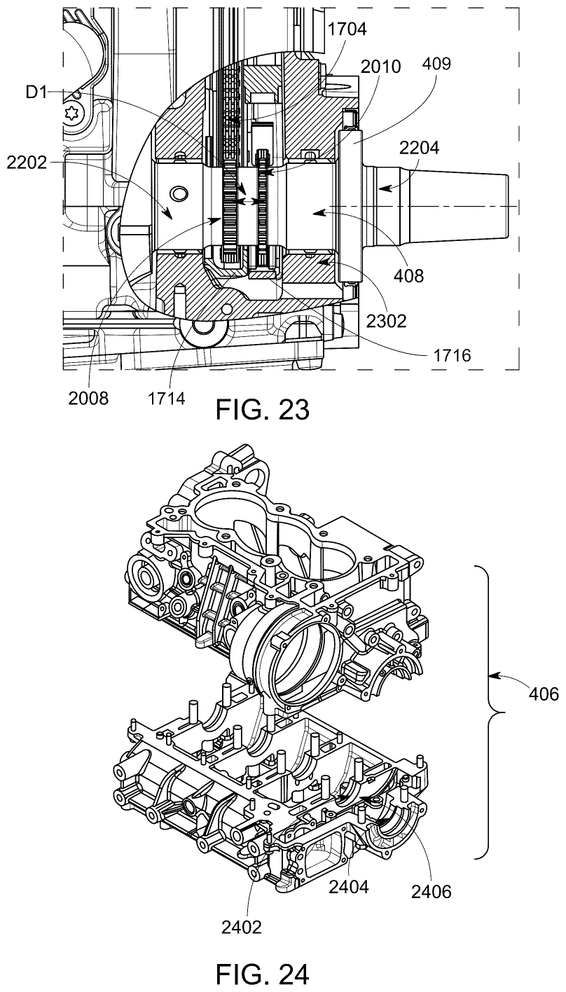

The drive chain assembly 1702 may be configured to be operated using the crankshaft 408 of the engine 302. Accordingly, the crankshaft 408 is configured to operate each of the timing chain 1704 and the auxiliary drive chain 1706. Both the timing chain 1704 and the auxiliary drive chain 1706 are attached at the same side of the engine 302, that is at the PTO side 410 (seen e.g., in FIGS. 17 and 23). The timing chain 1704 is located inboard of the auxiliary drive chain 1706 from the first end of the crankshaft 408. The first end of the crankshaft 408 corresponds to the first side (F2) or the PTO side 410 of the crankshaft 408.

The drive chain assembly 1702 may further include a plurality of chain guides 1710 attached to the crankcase 406 (seen e.g., in FIG. 17). The plurality of chain guides 1710 are configured to guide and tension the timing chain 1704 as well as the auxiliary drive chain 1706 in their intended movement. The plurality of chain guides 1710 are attached to the crankcase 406 at the first side (F2), i.e., the PTO side 410 of engine 302 or the crankshaft 408. The plurality of chain guides 1710 may be attached to the crankcase 406 using a plurality of fasteners 1718. The plurality of chain guides 1710 may be made of nylon material. The drive chain assembly 1702 further comprises a chain tensioner 1708 for adjusting tension of the timing chain 1704 between the crankshaft 408 and the at least one camshaft 2002 (seen e.g., in FIG. 17). The chain tensioner 1708 may be a hydraulic tensioner. In an embodiment, a tension of the timing chain 1704 is kept such that a minor movement of the timing chain 1704, while the engine 302 or the vehicle 100 is in operation, is allowed. The chain tensioner 1708 may be attached to a side of the crankcase 406 that is adjacent to the PTO side 410.

The drive chain assembly 1702 may further comprise a lower support 1712 (seen e.g., in FIGS. 17-19). The lower support 1712 is configured to be placed at a lower side of the crankcase 406 towards the ground and below the crankshaft 408. The lower support 1712 is configured to receive the timing chain 1704 and the auxiliary drive chain 1706 therewithin. For the same, the lower support 1712 includes a first guide portion 1714 for receiving the timing chain 1704 and a second guide portion 1716 for receiving the auxiliary drive chain 1706. The lower support 1712 is preferably a single piece but may alternatively be separate pieces for the first guide portion 1714 and the second guide portion 1716. The lower support 1712 is mainly configured to provide support to the timing chain 1704 and the auxiliary drive chain 1706. Moreover, the lower support 1712 may be configured to receive and contain lubricant in the first guide portion 1714 and the second guide portion 1716. The contained lubricant may provide lubrication to a portion of each of the timing chain 1704 and the auxiliary drive chain 1706 that passes through the first guide portion 1714 and the second guide portion 1716, respectively.

The first guide portion 1714 and the second guide portion 1716 are configured to be placed adjacent to each other (seen e.g., in FIG. 23). In other words, the timing chain 1704 and the auxiliary drive chain 1706 are placed adjacent to each other at the crankshaft 408. It is to be noted that width dimensions or distance between the timing chain 1704 and the auxiliary drive chain 1706 are preferably kept minimum respecting the requirements of known applications. Further, the width dimensions or distance between the timing chain 1704 and the auxiliary drive chain 1706 are typically the same across a family of vehicles.

For accommodating the timing chain 1704 at the PTO side 410, the crankshaft 408 comprises a timing chain sprocket 2008 (seen e.g., in FIGS. 20 and 23). The timing chain sprocket 2008 may be integrally formed in the crankshaft 408. A groove portion is formed in the crankshaft 408 for forming the timing chain sprocket 2008 therewithin. This configuration and formation of the sprocket 2008 allows for a small timing chain sprocket, which translates to smaller camshaft sprockets 2004 (see FIG. 20, for example). As the camshaft sprockets and drive sprocket 2008 needs to have a 2-to-1 ratio, keeping the drive sprocket 2008 small results in smaller camshaft sprockets 2004. Thus, the space envelope including the overall height and width of the engine is minimized. Preferably the timing chain sprocket 2008 and the auxiliary chain sprocket 2010, as well as the associated chains, have the same pitch such that the machining operation to cut the sprockets into the crankshaft is simplified. As the loads may differ from one chain to the other, the chain widths may differ. Preferably the auxiliary chain 1706 and sprocket 2010 is narrower than the timing chain 1704 and sprocket 2008.

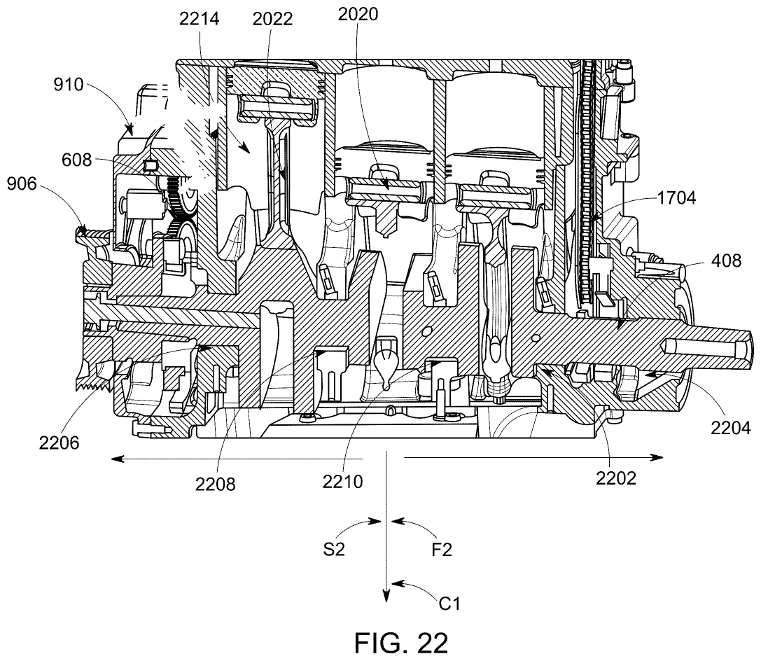

In some embodiments, the timing chain sprocket 2008 may formed as a separate piece and then attached to the crankshaft 408. Similar to the crankshaft 408, the at least one camshaft 2002 comprises a camshaft sprocket 2004 at the PTO side 410 for accommodating the timing chain 1704 (seen e.g., in FIG. 20). The at least one camshaft 2002 may comprise a first camshaft 2002A and a second camshaft 2002B. The first camshaft 2002A includes a first camshaft sprocket 2004A. The second camshaft 2002B includes a second camshaft sprocket 2004B. Accordingly, the camshaft sprocket 2004 is driven by the crankshaft 408 through the timing chain 1704. The camshaft sprocket 2004 further drives the at least one camshaft 2002 for opening and closing of intake and exhaust valves during the combustion process. In some embodiments, the first camshaft sprocket 2004A drives the first camshaft 2002A to open or close a plurality of first valves 2006A. The second camshaft sprocket 2004B drives the second camshaft 2002B to open or close a plurality of second valves 2006B. The plurality of first valves 2006A and the plurality of second valves 2006B may be intake valves and exhaust valves, and vice versa. The engine 302 comprises a plurality of cylinders 2214, and a plurality of pistons 2020 that is connected to a plurality of crankpins 2024 via a plurality of connecting rods 2022 (seen e.g., in FIGS. 20 and 22). The plurality of crankpins 2024 are configured to transmit the linear motion of the plurality of pistons 2020 into the rotational power for further operation of the engine 302.

For accommodating the auxiliary drive chain 1706 at the PTO side 410, the crankshaft 408 comprises an auxiliary drive chain sprocket 2010 (seen e.g., in FIGS. 20 and 23). The auxiliary drive chain sprocket 2010 is preferably an integral part of the crankshaft 408, formed therewith. It is to be noted that the auxiliary drive chain sprocket 2010 is to have a small sprocket size (similar to the timing chain sprocket 2008) while still having a required crankshaft diameter to deal with loads thereon. So that, the auxiliary drive chain sprocket 2010 is preferably cut (or otherwise formed) integral with the crankshaft 408. Alternatively, the auxiliary drive chain sprocket 2010 may formed as a separate piece and then attached to the crankshaft 408. Similar to the crankshaft 408, the coolant pump 2012 may comprise a coolant pump gear 2014 that is entrained with the auxiliary drive chain 1706 for driving the coolant pump 2012. In addition to or alternatively, the oil pump 2018 comprises at least one idler gear 2016 that is entrained with the auxiliary drive chain 1706 for driving the oil pump 2018.

In some embodiments, the crankshaft 408 is configured to receive a first main bearing 2202 and a second main bearing 2204 (seen e.g., in FIGS. 22-23). In some embodiments, the crankshaft 408 is a single piece crankshaft having an additional length 2302 for accommodating the second main bearing 2204, thereby making the crankshaft 408 as an extended crankshaft (seen e.g., in FIG. 23). The additional length 2302 of the crankshaft 408 corresponds to a length of the second main bearing 2204 accommodated in the crankshaft 408. In an exemplary embodiment, the additional length may be around 20 mm.

In some embodiments, the crankshaft 408 is extended out of the crankcase 406 on both sides. One or more chains and the gears of the drive chain assembly 1702 are located between the first main bearing 2202 and the second main bearing 2204. In other words, the first main bearing 2202 and the second main bearing 2204, respectively, are positioned on each side of at least one chain and associated gears of the drive chain assembly 1702. The first main bearing 2202 is positioned between the crankcase 406 and the drive chain assembly 1702. Accordingly, the first main bearing 2202 is inboard of the drive chain assembly 1702. Both the timing chain 1704 and the auxiliary drive chain 1706 may be placed between the first main bearing 2202 and the second main bearing 2204. The second main bearing 2204 is positioned between the drive chain assembly 1702 and the first end 414 of the crankshaft 408. Accordingly, the second main bearing 2204 is outboard of the drive chain assembly 1702. The first main bearing 2202 is positioned at a first main bearing location 2402 at the crankcase 406 (seen e.g., in FIG. 24). The second main bearing 2204 is positioned at a second main bearing location 2404 at the crankcase 406. In that respect, the second main bearing 2204 is housed within the crankcase 406. Further, an area 2406 for the drive chain assembly 1702 is used to gain a lever length between the first main bearing 2202 and the second main bearing 2204. Although both the timing chain 1704 and the auxiliary drive chain 1706 are shown as being positioned between the first main bearing 2202 and the second main bearing 2204, the present disclosure is not limited to such a configuration as it is to be understood that only one of either the timing chain 1704 or the auxiliary drive chain 1706 may be positioned between the main bearing 2202 and the second main bearing 2204.

In an illustrative example, the second main bearing 2204 is identical to the first main bearing 2202. Further, each of the first main bearing 2202 and the second main bearing 2204 is a plain and oil driven bearing. Referring to FIG. 22, similar to the first main bearing 2202, a plurality of main bearings 2206, 2208, 2210 are distributed along the crankshaft 408, The plurality of main bearings 2206, 2208, 2210 are placed between both sides of the crankcase 406. All the bearings in the crankshaft 408 are aligned similarly.

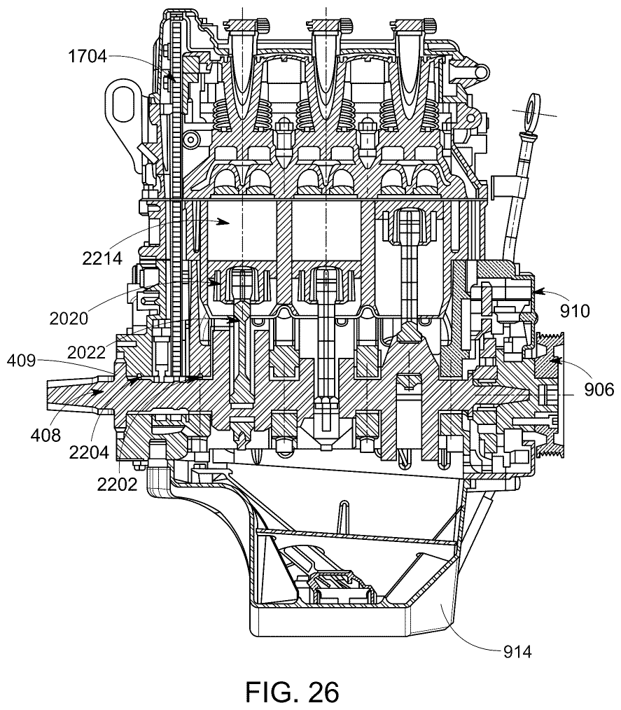

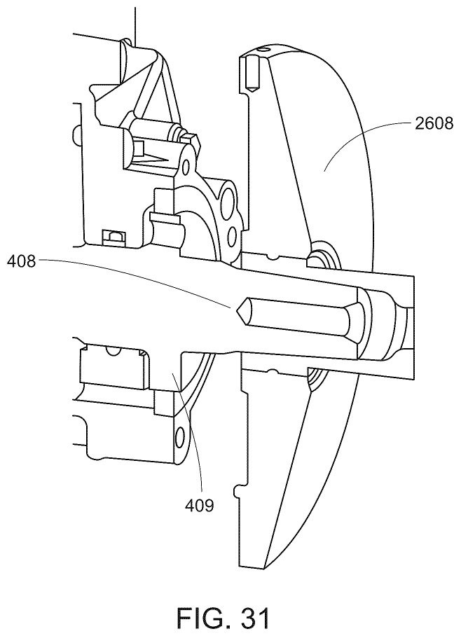

The second main bearing 2204 is added to the crankshaft 408 to help align the crankshaft 408 and deal with the load of the continuous variable transmission (CVT) 106 such as to balance weight of the CVT clutch sheeves 2608, thereby providing low noise level operation. As shown in FIG. 23, the additional length 2302 enables the crankshaft 408 to accommodate the second main bearing 2204 for reducing noise, it avoids separately attachable shaft and roller bearings with attendant seals. Furthermore, machining of the crankshaft 408 is simpler as it does not require an additional diameter that has to be concentric to the main bearing. FIG. 26 illustrates an exemplary cross-sectional view of the engine 302 with the external alternator 902 including the crankshaft 408 with the first main bearing 2202 and the second main bearing 2204. FIG. 31 illustrates a partial cross-sectional view of a single piece crankshaft 408 attached with the CVT inner clutch sheeve 2608.

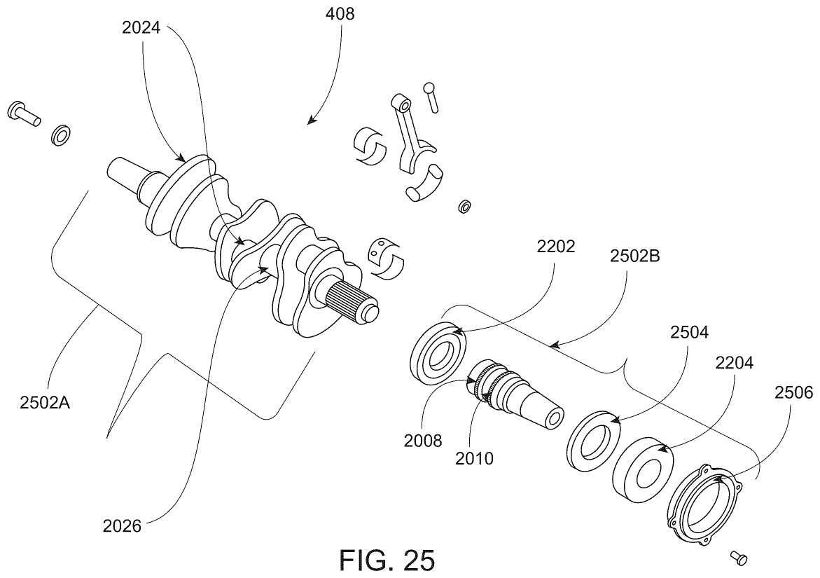

In some embodiments, the crankshaft 408 is a multipiece crankshaft (seen e.g., in FIGS. 25, 28, and 29). As shown in FIG. 25, the crankshaft 408 comprises a first part 2502A and a second part 2502B that is removably attached to the first part 2502A. The first part 2502A of the crankshaft 2502A comprises the plurality of crankpins 2024, a plurality of main journals 2026 and other associated parts. The second part 2502B comprises the first main bearing 2202, the timing chain sprocket 2008, the auxiliary drive chain sprocket 2010, the second main bearing 2204, an oil seal 2504, and a second bearing housing 2506 that constitute as an output assembly of the crankshaft 408. In some embodiments, the second main bearing 2204 is similar to the first main bearing 2202. The second main bearing 2204 may be different from the first main bearing 2202.

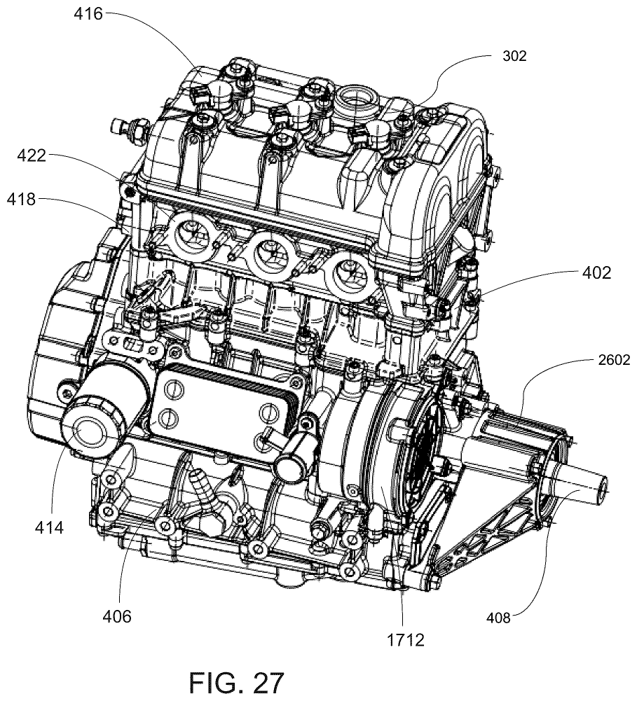

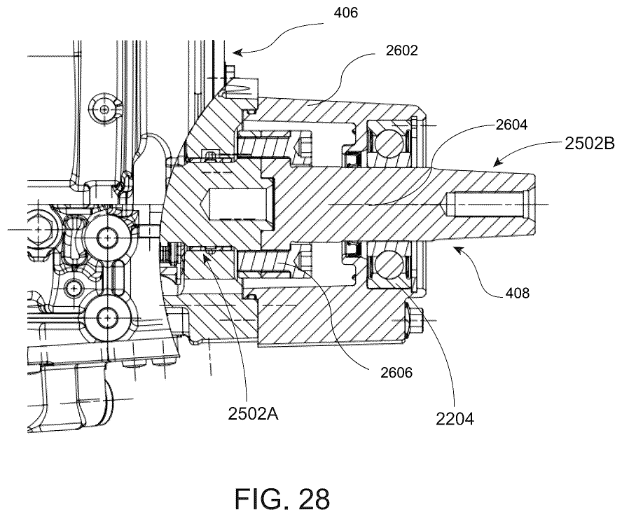

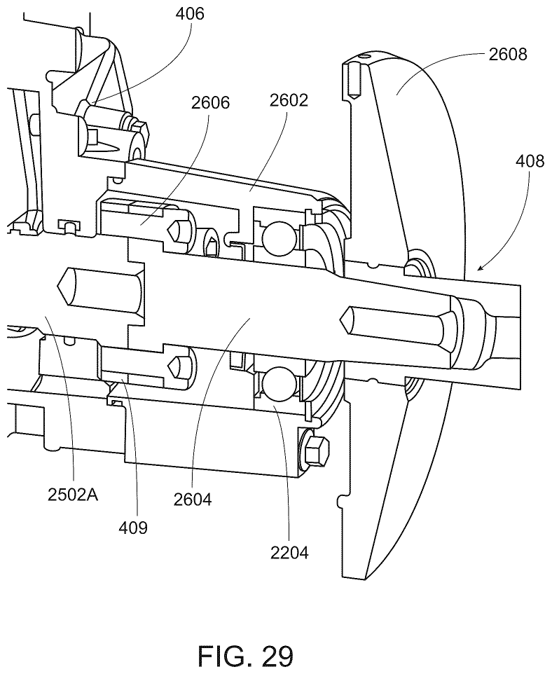

In some embodiments, the crankshaft 408 is configured to be attached with a crankshaft extension 2604 that is supported by a support bearing 2204 (seen e.g., in FIGS. 28 and 29). The support bearing 2204 may a roller bearing, thereby additional or active oil supply is not required. The crankshaft extension 2604 is secured to the first part 2502A with fasteners 2606 (FIG. 29). The crankshaft extension 2604 is covered or housed by a crankcase extension 2602 (FIGS. 27-29). The crankcase extension 2602 may be bolted or attached to the crankcase 406 using fasteners. FIGS. 28, 29, 30A-C illustrate cross-sectional and cross-sectional exploded views of a portion of the crankcase 406 with a crankcase extension 2602 for accommodating the crankshaft extension 2604. The crankshaft extension 2604 enables CVT clutches 2612, 2614 to be spaced further from the PTO side 410 of the engine 302 (seen e.g., in FIG. 32). In other words, the crankshaft extension 2604 enables to increase a distance between the CVT 106 and the engine 302. Accordingly, the engine 302 with the crankshaft 408 having the crankshaft extension 2604 may be used on snowmobiles with wide track 104 where the engine 302 is centrally located. Such that, the engine 302 may not be moved out of the center to move the CVT 106 to the outside. In some embodiments, the engine 302 may be used in any vehicles requiring that the CVT clutches 2612, 2614 be spaced further from the from the PTO side 410 of the engine 302. It is to be noted that a flange on the crank shaft 408 is used to bolt on the CVT fly wheel 2608 to lower an idling speed. In some embodiments, additional machining or modification may be done on the crankshaft 408 to couple or attach with the crankshaft extension 2604.

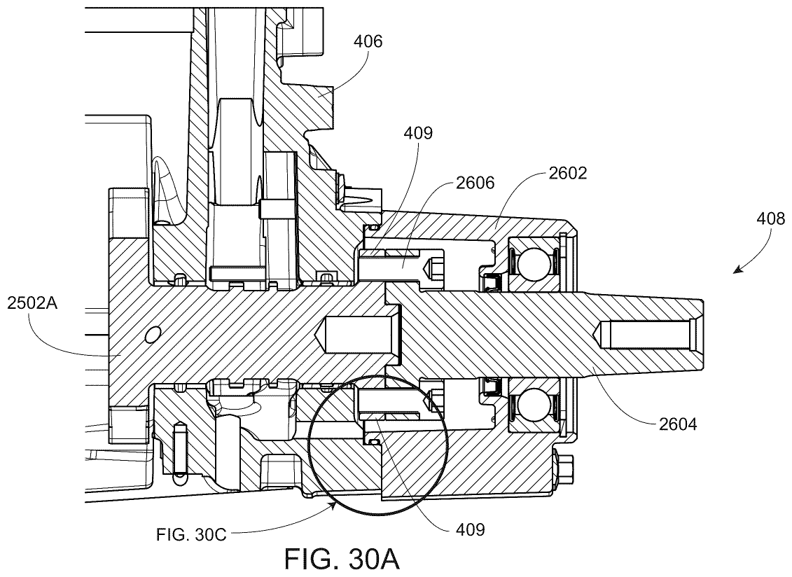

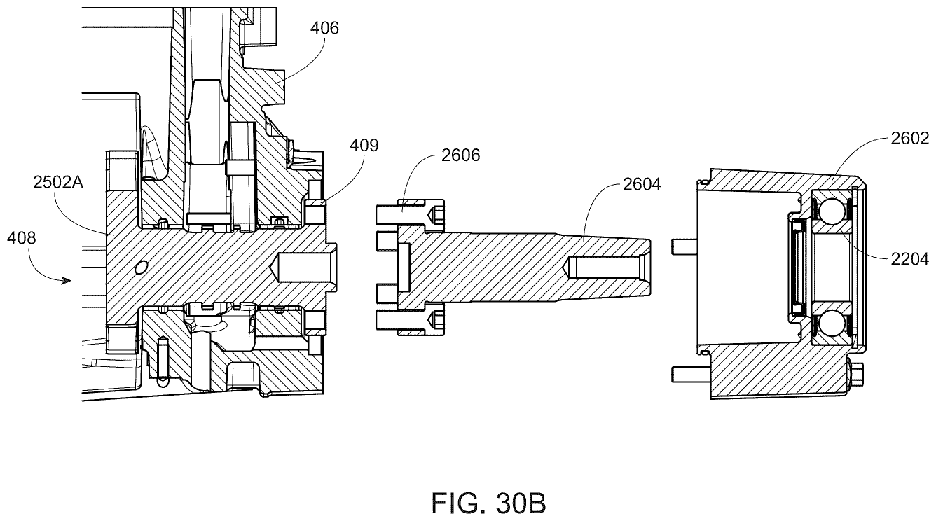

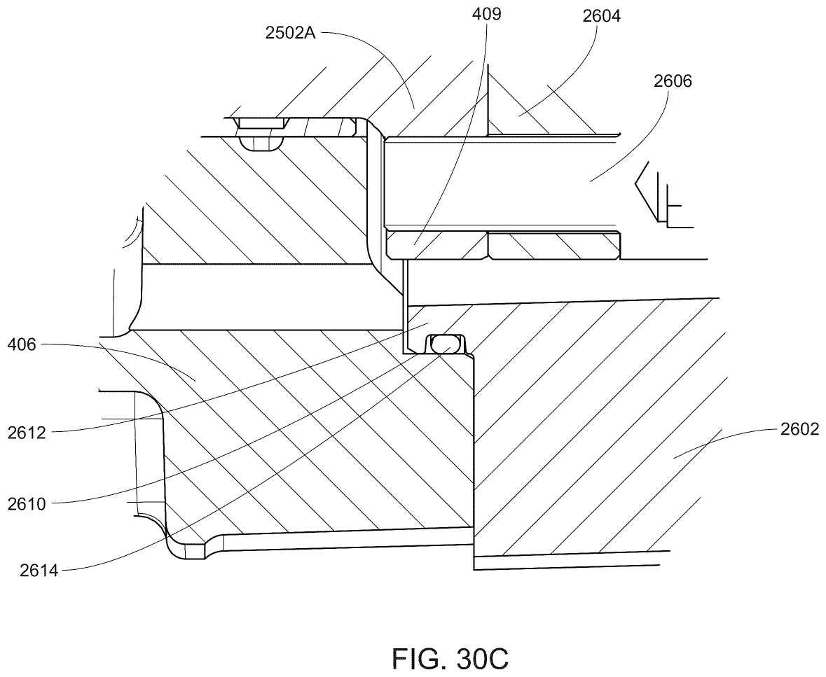

The standard crankshaft 408 shown in FIGS. 23 and 26 may be adapted to be used with the crankshaft extension 2604 (FIGS. 29, 30A, 30B, 30C) by cutting off (machining oft) the end of the standard, non-extending crankshaft adjacent the flange 409. Flange 409 is then used to secure the crankshaft extension 2604 using fasteners 2606 (FIGS. 29, 30A, 30B, 30C). On the non-extended crankshaft, flange 409 may be used to secure a flywheel 2608 as noted above. Preferably with either the extended crankshaft or the regular crankshaft, the other components are the same, thus reducing part count and common chassis connections. Thus, for example, the crankcase is the same including the same width as measured from the location for attachment of the crankcase extender that provides the bearing support for the extended crankshaft to the non-PTO side of the crankcase.

FIG. 30C shows the detail of the interface between the crankcase 406 and the crankcase extension 2602. An annual shoulder 2610 is preferably machined into the crankcase 406 to receive an L-shaped rim 2612 extending from an inboard end of the crankcase extension 2602. The rim 2612 includes a recess to receive a seal 2614. Thus, tight, sealed engagement is achieved between the crankcase 406 and the crankcase extension 2602.

The fasteners used throughout the present disclosure may be nut and. bolt fasteners used. in automobile industry. in some embodiments, the bolt in such fasteners may have a hex-head, followed by a hex-headed cap screw and a stud.

It is to be noted that different values and parameters mentioned in the description are exemplary in nature and are not intended to bound the specification in any manner.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. An engine assembly of an off-road vehicle, the engine assembly comprising:
an engine configured to generate a power;
the engine comprising a crankcase; a crankshaft housed in the crankcase; and a generator coupled to the crankshaft, the generator being selected from an internal generator and
an external alternator;
wherein the crankshaft is the same for the engine having any one of the internal generator and the external alternator.

2. The engine assembly of claim 1, wherein the engine with the internal generator is configured to have a first width and the engine with the external alternator is configured to have a second width, wherein the first width of the engine assembly is within ten percent of the second width of the engine assembly.

3. The engine assembly of claim 1, wherein the engine extends from a first side to a second side of a central axis of the vehicle in a longitudinal direction of the vehicle, wherein the first side corresponds to a Power Take Off (PTO) side of the engine, and is defined as a side of the engine with which a PTO shaft is coupled for receiving power from the engine, and the second side corresponds to a non-PTO side of the engine that is opposite to the first side, and wherein the generator is coupled to the crankshaft at the second side, wherein the crankshaft extends from the first side to the second side of the central axis, and further comprising a first cover when the engine includes the internal generator and a second cover when the engine includes the external alternator, wherein the first cover and the second cover is configured to be attached to the crankcase, on the second side of the engine.

4. The engine assembly of claim 1, wherein the external alternator is coupled to the crankshaft using an external alternator assembly, the external alternator assembly comprising a pulley and a belt, wherein the pulley is configured to be secured on a second end of the crankshaft and is configured to be rotated corresponding to rotation of the crankshaft, and wherein the belt is configured to transfer the rotation of the pulley to the external alternator for operating the external alternator.

5. The engine assembly of claim 4, comprising a compressor coupled with the crankshaft via the external alternator assembly, wherein the belt of the external alternator assembly is configured to couple the compressor to the pulley secured on the crankshaft and operate the compressor according to a rotation of the crankshaft.

6. The engine assembly of claim 3, wherein the second cover is configured to be used when the engine comprises the external alternator, the second cover comprising an opening for passing the crankshaft therethrough to secure the pulley over the crankshaft.

7. The engine assembly of claim 3, wherein each of the first cover and the second cover is configured to at least partially cover a starter motor assembly of the vehicle at the second side of the engine.

8. The engine assembly of claim 3, wherein the first cover is configured to completely cover a second end of the crankshaft at the second side of the engine, thereby the first cover is different from the second cover as the second end of the crankshaft protrudes outside of the second cover.

9. The engine assembly of claim 1, comprising a starter motor assembly having a gear assembly and a starter motor, wherein the starter motor assembly is the same for the engine having any one of the internal generator and the external alternator, wherein the gear assembly is positioned behind a pulley in case of the engine having the external alternator or positioned behind a flywheel and a stator in case of the engine having the internal generator.

10. The engine assembly of claim 1, further comprising a starter motor assembly positioned adjacent the crankcase, beneath an air intake of the engine.

11. The engine assembly of claim 1, further comprising a starter motor assembly positioned adjacent the crankcase, beneath an exhaust port of the engine.

12. An engine assembly for an off-road vehicle comprising:
a crankcase comprising a body including a first side and a second side opposite the first side;
a crankshaft positioned in the crankcase and including a first end extending outboard of the first side of the crankcase body;
a starter motor assembly comprising a starter motor secured to the crankcase body between the first side and the second side of the crankcase body with a rotational axis parallel to the rotational axis of the crankcase, and a gear assembly at least partially positioned outboard of the first side of the crankcase body and operatively connected to the crankshaft;
wherein the engine assembly is configured to be coupled to a generator, the generator being selected from an internal generator comprising a stator and a flywheel and an external alternator assembly comprising an alternator pulley, and wherein the starter motor and the gear assembly is the same for the engine having any one of the internal generator and the external alternator, and wherein the starter motor is positioned inboard of the stator and the flywheel of the internal generator and inboard of the alternator pulley of the external alternator.

13. The starter motor assembly of claim 12, wherein the main gear is positioned inboard of a flywheel in case of the internal generator or positioned inboard of a pulley in case of the external alternator.

14. The starter motor assembly of claim 12, wherein the starter motor is positioned such that a longitudinal axis of the starter motor is parallel to a rotational axis of the crankshaft, wherein the starter motor is positioned inward to a side plane of the generator, the side plane of the generator being defined as a plane passing through the second side of the engine.

15. An engine assembly of an off-road vehicle, comprising:
a crankcase;
a crankshaft within the crankcase, the crankshaft having a first end and a second end;
a starter motor assembly having a gear assembly drivingly coupled to the crankshaft on the first end of the crankshaft;
a generator coupled to the first end of the crankshaft;
a cover extending over an outboard side of the generator and over an outboard side of the gear assembly of the starter motor assembly.

16. An engine assembly of an off-road vehicle comprising:
a crankshaft extending from a first side to a second side of a central axis of the vehicle in a longitudinal direction thereof;
at least one camshaft, and
a drive chain assembly located at the first side of the crankshaft, wherein the drive chain assembly comprises a timing chain for driving the at least one camshaft corresponding to a rotation of the crankshaft and an auxiliary drive chain for driving a pump;
wherein the timing chain is located inboard of the auxiliary drive chain from a first end of the crankshaft, wherein the first end of the crankshaft corresponds to the first side of the crankshaft.

17. The engine assembly of claim 16, wherein each of the timing chain and the auxiliary drive chain is a silent chain.

18. The engine assembly of claim 17, wherein the timing chain and the auxiliary chain are both positioned on a first side of the engine assembly and further comprising a generator positioned on a second side of the engine assembly, wherein the generator is selected from an internal generator and an external alternator.

19. The engine assembly of claim 16, wherein the drive chain assembly further comprises a plurality of chain guides attached to a crankcase at the first side for guiding the timing chain and the auxiliary drive chain, and a chain tensioner located at a side of the crankcase adjacent to the first side thereof for adjusting tension of the timing chain and, wherein the timing chain and auxiliary drive chain run adjacent and parallel to each other and wherein the drive chain assembly further comprises a lower support for supporting the timing chain and the auxiliary drive chain, the lower support being positioned at a lower side of the crankshaft towards the ground.

20. The engine assembly of claim 19, wherein the lower support comprises a single piece with two portions.

21. The engine assembly of claim 16, wherein the auxiliary drive chain is configured to drive a coolant pump of the vehicle and an oil pump of the vehicle on a common fore-aft side of the crankshaft.

22. The engine assembly of claim 16, wherein the crankshaft comprises a timing chain sprocket and an auxiliary drive chain sprocket, wherein the timing chain sprocket and the auxiliary drive chain sprocket are integrally formed in the crankshaft, the timing chain sprocket being inboard of the auxiliary drive chain sprocket, and wherein the crankshaft comprises a groove portion for forming the timing chain sprocket.

23. The engine assembly of claim 22, wherein the pitch of the timing chain sprocket is the same as the pitch of the auxiliary chain sprocket.

24. An engine assembly of an off-road vehicle comprising:
a crankcase including a first side and a second side;
a crankshaft positioned in the crankcase and extending out of the first side of the crankcase;
a plurality of cylinders;
a first main bearing positioned on the crankshaft;
a second main bearing positioned on the crankshaft; and
a drive chain operatively connected to the crankshaft;
wherein the drive chain is located between the first main bearing and the second main bearing.

25. The engine assembly of claim 24, wherein the engine extends from a first side to a second side of a central axis of the vehicle in a longitudinal direction thereof, wherein the first side corresponds to a Power Take Off (PTO) side of the engine, and is defined as a side of the engine with which a PTO shaft is coupled for receiving power from the engine, and the second side corresponds to a non-PTO side of the engine that is opposite to the first side, the drive chain being on the PTO side of the engine.

26. The engine assembly of claim 24, wherein the crankshaft is an extended crankshaft having an additional length for accommodating the second main bearing, wherein the crankshaft is extended out of the crankcase.

27. The engine assembly of claim 24, wherein the drive chain assembly includes a timing chain for driving at least one camshaft and an auxiliary drive chain for driving an oil pump, wherein the timing chain and the auxiliary drive chain are located between the pair of main bearings at the first side of the engine.

28. The engine assembly of claim 27, wherein the auxiliary drive chain is further configured to drive a coolant pump on the same side of the crankshaft as the oil pump.

29. The engine assembly of claim 24, wherein each of the first main bearing and the second main bearing is a plain bearing.

30. An engine assembly of an off-road vehicle comprising:
an engine having a crankshaft, the engine extending from a first side to a second side of a longitudinal central axis of the vehicle, the first side corresponds to a Power Take Off (PTO) side of the engine, and the second side corresponds to a non-PTO side of the engine that is opposite to the first side; and
a crankshaft extension configured to be attached to the PTO side of the engine for extending a distance between the engine and a continuous variable transmission (CVT) assembly on the PTO side.

31. The engine assembly of claim 30, wherein the crankshaft extension is supported by a support bearing, wherein the support bearing comprises a roller bearing, and wherein the crankshaft extension with respect to the support bearing is covered or housed by a crankcase extension.

32. The engine assembly of claim 31, further comprising a continuously variable transmission coupled to the crankshaft extension.

33. The engine assembly of claim 32, wherein the engine is adapted for use in a wide-track snowmobile, the continuously variable transmission being coupled to drive a snowmobile track.

34. The engine assembly of claim 30, wherein the engine assembly is adapted to be used without the crankshaft extension in a snowmobile having a regular width track, the engine assembly further comprising a continuously variable transmission secured to the PTO side of the crankshaft, wherein the engine assembly is secured within a chassis of the snowmobile aligned within the chassis the same as within a wide track snowmobile.

35. A method of producing wide-track and regular-width-track snowmobiles with a common engine assembly, the method comprising:
a. selecting a common engine assembly having a crankshaft with a power-take-off (PTO) side;
b. attaching a crankshaft extension to the PTO side of the crankshaft for wide-track snowmobiles;
c. securing the common engine assembly to a chassis; and
d. securing a continuously variable transmission (CVT) to the PTO side of the crankshaft, the CVT being attached to the non-extended crankshaft for a regular-width-track snowmobile or to the extended crankshaft for the wide-track snowmobile.

36. The method of claim 35, wherein the engine position with a forward portion of the chassis is the same for the wide-track snowmobile as for the regular-width-track snowmobile.

37. The method of claim 36, wherein body panels of similar size are secured to the forward portion of the snowmobile chassis for both the wide-track snowmobile and for the regular-track-width snowmobile other than a portion that surrounds the CVT.

38. The method of claim 35, wherein a portion of the crankshaft is machined off prior to attachment of the crankshaft extension, the crankshaft having a flange for securement of the crankshaft extension.
